(19) United States
(12) Patent Application Publication
(10) Pub. No.: US 2006/0240350 A1
(43) Pub. Date: Oct. 26, 2006

(54) Developer, and image forming apparatus and process cartridge using the developer

(76) Inventors: Hyo Shu, Mishima-shi (JP); Mitsuo Aoki, Numazu-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/408,031

(22) Filed: Apr. 21, 2006

(30) Foreign Application Priority Data
Apr. 22, 2005 (JP) 2005-124586
Apr. 22, 2005 (JP) 2005-124626
Apr. 10, 2006 (JP) 2006-107264
Apr. 10, 2006 (JP) 2006-107413

(51) Int. Cl. G03G 9/08

(52) U.S. Cl. 430/108.6; 430/108.23; 430/109.1; 430/111.41

(57) ABSTRACT

A developer contains a toner; and a carrier, wherein the toner contains toner particles containing a binder resin; and a colorant, and a titanium oxide as an external additive, wherein an amount of free titanium oxide particles released from the toner determined by a ultrasonic vibration method is from 5 to 22% by weight per total weight of the toner, and wherein the toner has a charge quantity distribution property so that a peak is present in a charge quantity range of from 20 to 40 μC/g in absolute value, wherein the charge quantity distribution of the toner is determined by an increment method in which the developer including the toner is subjected to a blow off treatment to measure a charge quantity of the toner at 23° C. and 55% RH.

### BACKGROUND OF THE INVENTION

1. Field of the Invention

The present invention relates to a developer for use in an electrophotographic image forming apparatus. In addition, the present invention relates to an image forming apparatus and a process cartridge using the developer.

2. Description of the Related Art

U.S. Pat. No. 2,297,691, 3,666,363 and 4,071,361 (hereinafter referred to as USP) have disclosed various kinds of electrophotography. Typically, in electrophotography, an image is formed as follows:
(1) an electrostatic latent image is formed on an image bearing member;
(2) the electrostatic latent image is developed with a toner to form a toner image on the image bearing member;
(3) the toner image is transferred onto a transfer material such as paper; and
(4) the toner image is fixed on the transfer material by application of heat, pressure or solvent vapors while toner particles remaining on the image bearing member are removed.

Many kinds of developing methods for developing an electrostatic latent image with a toner, are known. These developing methods are broadly classified into two categories: dry developing methods and wet developing methods. Recently, dry developing methods have been generally used. Further, dry developing methods are broadly classified into two categories: developing methods using an one-component developer and developing methods using a two-component developer.

The one-component developer consists of a toner. A magnetic one-component developer consists of a toner having a magnetic material, and a non-magnetic one-component developer consists of a toner having no magnetic material. Specific examples of the developing methods using these one-component developers include a powder cloud method (disclosed in U.S. Pat. No. 2,221,776), a magnet dry method, an impression method, etc.

The two-component developer is a mixture of a toner, in which a colorant (such as carbon black) is dispersed in a binder resin, and a carrier consisting of an iron powder, a glass bead, or the like. Specific examples of the developing methods using these two-component developers include a magnetic brush method (disclosed in U.S. Pat. No. 2,874,063) using an iron powder carrier, a cascade method (disclosed in U.S. Pat. No. 2,618,552), etc.

However, a toner only including a binder resin and a colorant has poor properties in fluidity, fixability and developability.

For example, in a fixing process, offset problem tends to be caused in which part of a fused toner image, which is contacted with the surface of a fixing roller under pressure, is adhered and transferred to the surface of the fixing roller, and then the part of the toner image is re-transferred to an undesired portion of the sheet itself or the following sheet of a recording material. In attempting to prevent occurrence of the offset problem, a technique in which the surface of the fixing roller is coated with a material having high releasability such as silicone rubbers and fluorocarbon resins has been proposed. Further, a technique in which a release oil such as a silicone oil is applied to the surface of the fixing roller has been proposed. This technique has an advantage in terms of preventing occurrence of the offset problem, but the fixing device needs an oil feeding device and therefore the image forming apparatus is upsized. Recently, a technique is broadly used in which a toner including a release agent is used in combination with oilless fixing devices without a fixing oil applying system or fixing devices applying a small amount of oil. Such a release agent imparts releasability to the toner, but on the other hand, increases adhesion thereof, resulting in deterioration of fluidity of the toner.

In attempting to improve fluidity of the toner, a technique in which inorganic oxides serving as an external additive such as silica, titania, alumina, etc. are added to the toner has been proposed.

Typically, fluidity and chargeability of the toner can be enhanced by adding external additives thereto. However, a problem is that external additive particles which do not adhere to the toner particles (hereinafter referred to as free external additive particles) adhere to the surface of the carrier and deteriorates charging ability thereof. Such contaminated carrier causes a carrier adherence problem and a toner falling problem (which are explained below). The carrier adherence problem is such that a carrier adheres to the surface of an image bearing member. At a portion of the image bearing member in which the carrier is adhered, an electrostatic latent image cannot be formed, therefore abnormal images having white spots are produced. The toner falling problem is such that a toner falls off from a developing sleeve in the machine. This problem is caused because the toner cannot be sufficiently friction-charged by the contaminated carrier in a developing device, and thereby the toner receives a low electrostatic force from the electric field applied to the developing section. Thereby, the toner cannot be transported from the developing sleeve to the image bearing member, and falls off from the developing sleeve in the machine. The fallen toner particles adhere not only to machine components such as sensors but also to recording papers. When the toner falls off on the recording paper, produced image quality deteriorates both in image area and non-image area.

Even if external additive particles are uniformly adhered to mother toner particles, i.e., free external additive particles do not exist in initial toner, the existential condition of the external additive particle changes as the number of produced printings increases. In other words, the amount of external additive particles embedded in or released from the mother toner particles increases as the number of produced printings increases.

Thereby, fluidity of the toner decreases with time, and therefore the toner cannot be uniformly charged. Namely, chargeability of the toner decreases with time, resulting in occurrence of toner scattering and background fouling.

Recently, the image producing speed of such image forming apparatus has been remarkably increased. As a result, two-component developers including a toner and a carrier are broadly used for such high-speed machines. It is because two-component developers can be quickly charged. However, when a two-component developer is agitated in a development unit, the toner and the carrier therein collide with each other. Thereby, the external additive particles in the toner are embedded in or released from the mother toner particles. The released external additive particles (i.e., the free external additive particles) tend to adhere to the carrier. Such deteriorated toner and carrier adversely affect charge quantity distribution and fluidity of the developer. Therefore, durability of the developer deteriorates, resulting in shortening of life of the developer.

In attempting to solve these problems, published unexamined Japanese Patent Application No. (hereinafter referred to as JP-A) 10-26861 discloses a technique in which a fallen toner collection system is arranged in an image forming apparatus in order to prevent contamination of machine components with the fallen toner.

JP-A 2002-311694 discloses a technique in which a dust-proof glass is arranged in an image forming apparatus in order to prevent contamination of a light scanning device with the fallen toner.

JP-A 09-265224 discloses a technique in which a developing device is properly arranged so as not to contaminate the image bearing member with the fallen toner.

However, above-mentioned techniques are improvements for image forming apparatus, and not for the fallen toner itself. Therefore, these methods cannot sufficiently prevent the problems caused by free external additives.

JP-As 2005-10246, 2005-10527, 2003-228189 and 2004-101648 have disclosed toners having specific charge quantity distributions (e.g., peak width and peak value). In these publications, the amount of toner particles having a charge quantity of not greater than 5 μC/g in absolute value (i.e., weakly charged toner particles) and reversely charged toner particles are mainly controlled. However, it is insufficient for preventing the toner falling problem to exclude only toner particles having a charge quantity of not greater than 5 μC/g in absolute value, to sharpen the charge quantity distribution, or to shift the peak of the charge quantity distribution to the high charge quantity side.

Moreover, such toner properties are determined without considering changes of the toner with time caused by application of mechanical stresses (such as agitation of the toner and the carrier in the developing device) thereto. Therefore, especially occurrence of the toner falling problem cannot be sufficiently prevented by such techniques.

Japanese Patent No. 3309294 discloses a toner including a silica as an external additive. In attempting to prevent deterioration of fluidity of the toner, a technique is proposed in which the amounts of silica particles embedded in, silica particles adhered to the surface of the mother toner and free silica particles are specified.

However, because silica itself has a high charge quantity, the toner mixed with a silica also has a high charge quantity. Such a toner cannot be stably charged, and thereby uniform solid images cannot be stably produced.

JP-A 9-218529 discloses a white toner, used for development of low-potential contrast, on which a specific amount of a particulate inorganic material such as titanium oxide is strongly adhered. However, the condition of the free titanium oxide after the toner is repeatedly used is not discussed therein.

### SUMMARY OF THE INVENTION

Accordingly, an object of the present invention is to provide a developer having the following properties after a long repeated use:
(1) external additives of the toner hardly adhere to the carrier;
(2) charge quantity distribution of the toner is stable; and
(3) the toner hardly falls off from a developing sleeve and do not contaminate machine components and produced images.

Another object of the present invention is to provide an image forming apparatus and a process cartridge by which high quality images can be stably produced.

These and other objects of the present invention, either individually or in combinations thereof, as hereinafter will become more readily apparent can be attained by a developer, comprising:

a toner; and

a carrier,

wherein the toner comprises:
toner particles comprising:
   a binder resin; and
   a colorant, and
a titanium oxide as an external additive,

wherein an amount of free titanium oxide particles released from the toner determined by a ultrasonic vibration method is from 5 to 22% by weight per total weight of the toner, and

wherein the toner has a charge quantity distribution property so that a peak is present in a charge quantity range of from 20 to 40 μC/g in absolute value, wherein the charge quantity distribution of the toner is determined by an increment method in which the developer including the toner is subjected to a blow off treatment to measure a charge quantity of the toner at 23° C. and 55% RH;

and an image forming apparatus and a process cartridge using the above developer.

### BRIEF DESCRIPTION OF THE DRAWINGS

These and other objects, features and advantages of the present invention will become apparent upon consideration of the following description of the preferred embodiments of the present invention taken in conjunction with the accompanying drawings, wherein:

FIG. 1 is a schematic view illustrating an embodiment of the image forming apparatus of the present invention;

FIG. 2 is a schematic view illustrating an embodiment of the developing device of the image forming apparatus illustrated in FIG. 1; and

FIG. 3 is a schematic view illustrating an embodiment of the process cartridge of the present invention.

### DETAILED DESCRIPTION OF THE INVENTION

Charge Quantity Distribution

The developer of the present invention includes a toner having a charge quantity peak in a range of from 20 to 40 μC/g in absolute value.

To produce high quality images, toners are required to have good charge stability as well as good initial charging ability. Since a developer including a toner and a carrier is agitated in a developing unit, external additive particles weakly adhered to the surface of the toner tend to release therefrom, resulting in production of free external additive particles. In particular, among known external additives, titanium oxide tends to easily adhere to the surface of the carrier.

Such contaminated carrier deteriorates in frictional charging ability, and causes problems such as the carrier adherence problem and the toner falling problem. In an image portion where the carrier adherence problem or the toner falling problem occurs, the toner cannot be transferred. Therefore, an abnormal image having white spots is produced. On the other hand, external additive particles remaining on the surface of the toner are embedded by collision and friction between the toner particles, and between the toner particles and the carrier and the developing unit. Thereby, the toner cannot be uniformly charged, resulting in production of abnormal images having background fouling.

The developer of the present invention includes a toner having a charge quantity peak in a range of from 20 to 40 μC/g in absolute value, preferably from 20 to 30 μC/g in absolute value. The charge quantity peak value includes all values and subvalues therebetween, especially including 21, 22, 23, 24, 25, 26, 27, 28, 29, 30, 31, 32, 33, 34, 35, 36, 37, 38 and 39 μC/g. In this case, production of abnormal images having background fouling can be prevented, even if some external additive particles are embedded in the toner particles. When the charge quantity peak value is too small, the toner cannot be sufficiently charged when the external additive particles are embedded therein, resulting in production of abnormal images having background fouling. When the charge quantity peak value is too large, the developability of the toner decreases, resulting in deterioration of the image density.

As mentioned above, the developer of the present invention includes a toner having a charge quantity peak in a range of from 20 to 40 μC/g in absolute value. Further, the toner preferably includes toner particles having a charge quantity of not greater than 14 μC/g in absolute value in an amount of not greater than 0.8 mg per 10 g of the toner.

In a developing process, the carrier forms magnetic brushes on a developing sleeve due to a magnetic force, while the toner, charged by friction with the carrier, adheres to the magnet brushes due to a Coulomb force. The charged toner moves from the developing sleeve to an electrostatic latent image formed on an image bearing member due to the potential difference generated therebetween, resulting in development of the electrostatic latent image. The following conditions are necessary in a developing process:
(1) the electrostatic force applied to the toner is larger than the Coulomb force generated between the toner and the carrier; and
(2) the toner receives an electrostatic force large enough to overcome the air resistance on the way to the image bearing member and gravity thereof.

However, generally, the toner is a fine particle having a particle diameter of not larger than 15 μm, and a developing gap is narrow having a distance of not larger than 3 mm. As a result, air resistance and gravity hardly influence on the toner. The phenomenon in which the toner does not move from the developing sleeve to the electrostatic latent image and falls off in the machine (i.e., the toner falling problem) is caused by the following reason. Specifically, the centrifugal force, which is generated by the rotation of the developing sleeve and which is applied to the toner, is smaller than the Coulomb force generated between the toner and the carrier, and the electrostatic force applied to the toner.

We have performed a running test, and collected fallen toner particles for analysis. It was found that not only weakly charged toner particles but also toner particles having a charge quantity of not greater than 14 μC/g in absolute value are the main components of the fallen toner.

As mentioned above, the developer of the present invention includes a toner having a charge quantity peak in a range of from 20 to 40 μC/g in absolute value. In addition, the toner preferably includes toner particles having a charge quantity of not greater than 14 μC/g in absolute value in an amount of not greater than 0.8 mg per 10 g of the toner. The amount of toner particles having a charge quantity of not greater than 14 μC/g in absolute value includes all values and subvalues therebetween, especially including 0.7, 0.6, 0.5, 0.4, 0.3, 0.2 and 0.1 mg per 10 g of the toner.

When the charge quantity peak value is too small, the amount of toner particles having a charge quantity of not greater than 14 μC/g in absolute value increases even if the charge quantity distribution is sharp, resulting in occurrence of the toner falling problem. When the charge quantity peak value is too large, the amount of toner particles used for development under the same potential difference condition decreases, resulting in deterioration of the image density. When the toner includes toner particles having a charge quantity of not greater than 14 μC/g in absolute value in an amount of not greater than 0.8 mg per 10 g of the toner, the toner falling problem and deterioration of image density do not occur even if the charge quantity distribution is not sharp.

The charge quantity distribution of the toner can be measured by the following increment method.

At first, 6 g of a developer is agitated for 780 seconds using a magnetic roller rotated at a revolution of 285 rpm. The charge quantity distribution of 1 g of the agitated developer is measured using a blow off device (manufactured by Ricoh Sozo Kaihatsu Co., Ltd.) at 23° C., 55% RH. The detailed measurement conditions are described in JP-A 8-313487, incorporated herein by reference.

A 795-mesh sieve is used for the blow off device.

The operation program of the increment method is shown in Table 1.

TABLE 1

| Measurement step | Height of nozzle | Suction force |
|---|---|---|
| P1 | 160 | 5 |
| P2 | 160 | 20 |
| P3 | 160 | 35 |
| P4 | 160 | 50 |
| P5 | 160 | 65 |
| P6 | 160 | 100 |
| HH7 | 80 | 100 |
| HH8 | 40 | 100 |
| HH9 | 20 | 100 |
| HH10 | 5 | 100 |

The POISSON probability distribution of the toner particles obtained in each step is determined by the following equation:
M=(m×e^{-λ}×λ^{X})/X

wherein M (mg/10 g) represents a charge quantity probability distribution in each step, m (mg/10 g) represents an amount of a toner blown off in each step, X represents a charge quantity channel (i.e., an integer of from 1 to 100 having units of μC/g), λ represents an average (a charge quantity measured in each step).

A graph in which the integral charge quantity (μC/g) is plotted on the X-axis and the total of M (μC/g) measured in each step is plotted on the Y-axis is prepared to obtain a charge quantity distribution curve.

In the charge quantity distribution curve of the toner included in the developer of the present invention, a peak is observed in the charge quantity range of from 20 to 40 μC/g in absolute value. The total amount of M when the charge quantity (on X-axis) is from 1 to 14 is defined as the probability of toner particles having a charge quantity of not grater than 14 μC in absolute value.

All known carriers such as magnetic powders (e.g., iron powders, ferrite powders and nickel powders), glass beads, etc. can be used for the carrier for use in the developer of the present invention. It is preferable that the carrier includes a cover layer including a resin. Specific examples of the resin include polycarbon fluoride, polyvinyl chloride, polyvinylidene chloride, phenol resins, polyvinyl acetal, acrylic resins, silicone resins, etc. The cover layer can be formed by known methods such as spray coating, dip coating, etc.

The developer preferably includes the toner in an amount of from 1 to 15 parts by weight, and more preferably from 4 to 10 parts by weight, based on 100 parts of the carrier. The amount of the toner includes all values and subvalues therebetween, especially including 2, 3, 4, 5, 6, 7, 8, 9, 10, 11, 12, 13 and 14 parts by weight based on 100 parts of the carrier.

Amount of Free Titanium Oxide Particles

The amount of free titanium oxide particles released from the toner for use in the developer of the present invention determined by a ultrasonic vibration method (after-mentioned) is from 5 to 22% by weight per total weight of the toner.

The toner for use in the developer of the present invention can include a wax with respect to the improvement of oilless fixability. But on the other hand, the wax increases adhesion of the toner and thereby fluidity thereof decreases. Therefore, a particulate inorganic material is added to the toner as an external additive (i.e., fluidizer) to improve fluidity and chargeability. However, the particulate inorganic material imparts too high chargeability to the toner. In order to decrease such a high chargeability, titanium oxide is added to the toner.

As mentioned above, the toner falling problem occurs when a Coulomb force generated by the friction between a toner and a carrier is weak. Frictional charging ability of a developer deteriorates as the conditions of the surfaces of a toner and a carrier change. The particulate inorganic material is embedded in or released from the mother toner particles by application of mechanical stress such as agitation in the developing unit. Thereby, free inorganic material particles are produced. Such free inorganic material particles adhere to the carrier and deteriorate charging ability of the carrier. In particular, among known external additives, titanium oxide tends to easily adhere to the surface of the carrier.

In order to solve these problems, the amount of the external additive particles released from the toner needs to be controlled. As mentioned above, problems such as the toner falling problem gradually occurs as the number of printings increases. Therefore, it is important to grasp properties of damaged toner (i.e., a mechanical stress being applied to the toner by agitation in the developing unit) with time in controlling the amount of the external additive particles released from the toner, not the initial (fresh) toner.

The amount of free titanium oxide particles released from the toner for use in the developer of the present invention determined by the ultrasonic vibration method (after-mentioned) is preferably from 5 to 22% by weight per total weight of the toner, and more preferably from 5 to 20% by weight per total weight of the toner. The amount of free titanium oxide particles includes all values and subvalues therebetween, especially including 6, 7, 8, 9, 10, 11, 12, 13, 14, 15, 16, 17, 18, 19, 20 and 21% by weight. In this case, the toner falling problem does not occur even if a mechanical stress is applied to the developer in the developing unit. When the amount of free titanium oxide particles is too small, it means titanium oxide particles strongly adhere to the toner and are embedded therein by application of a mechanical stress by agitation in the developing unit. Therefore, titanium oxide cannot work for decreasing charge quantity of the toner, resulting in deterioration of developability and image density. When the amount of free titanium oxide particles is too large, free titanium oxide particles adhere to the carrier and cause the carrier adherence problem and the toner falling problem, resulting in production of abnormal solid images having white spots.

In the present invention, the amount of free titanium oxide particles is measured by the ultrasonic vibration method mentioned below.

Conventionally, the amount of free external additive particles is measured using PARTICLE ANALYZER SYSTEM (manufactured by Horiba, Ltd.). In this method, the amount of free specific atom originated from the external additive is measured based on C atom. However, the amount of free external additive particles measured by this method can only reflect the condition of the initial (fresh) toner, and cannot reflect the condition of the toner after application of a mechanical stress in the developing unit. The amount of free external additive particles measured by the ultrasonic vibration method of the present invention can reflect the condition of the toner under application of a mechanical stress in the developing unit. Therefore, by controlling the amount of free external additive particles measured by the ultrasonic vibration method, occurrence of the toner falling problem can be prevented.

The ultrasonic vibration method is as follows:
(1) A mixture of 100 ml of ion-exchange water and 4.4 ml of DRIWEL (from Fuji Photo Film Co., Ltd.) having a concentration of 33% is agitated for 1 minute to prepare a solution A;
(2) Five (5) g of an initial toner is added to the solution A, and then the mixture is shaken for 20 times so that the toner gets wet, followed by leaving the mixture at rest for 30 minutes to prepare a solution B;
(3) The solution B is shaken for 5 times so that the toner is dispersed, and then the solution B is vibrated for 1 minute using HOMOGENIZER VCX750 (from Sonics Corporation) at an output energy of 30% by intruding a vibration part thereof into the solution B at a length of 2.5 cm, to prepare a solution C;
(4) The solution C is left at rest for 10 minutes, followed by filtration using a filter paper 110 mmΦ 100CIRCLES (from Toyo Roshi Kaisha, Ltd.);
(5) The toner remaining on the filter paper is subjected to drying in a thermostatic chamber at 40° C. for 8 hours;
(6) Three (3) g of the dried toner is pelletized using an automatic pressurization forming machine T-BRB-32 (from Maekawa Testing Machine MFG. Co., Ltd.) with a load of 6.0 t and at a pressurization time of 60 seconds, to prepare a pellete of the treated toner having a diameter of 3 mm and a thickness of 2 mm;
(7) A pellete of a non-treated toner is prepared by the same method mentioned above;
(8) The pellets are subjected to quantitative analysis to determine the amount of Ti atom using a fluorescent X-ray spectrometer ZSX-100e (from Rigaku Corporation), in which a calibration curve is prepared in advance using toner pellet samples having 0.1 parts, 1 part and 1.8 parts by weight of titanium oxide, respectively; and
(9) The amount of free titanium oxide particles (r) is determined by the following equation:
   r(%)=(B−A)/B×100

wherein A represents the amount of Ti atom included in the treated toner and B represents the amount of Ti atom included in the non-treated toner.

The amount of free titanium oxide particles can be controlled by controlling the mixing conditions with mother toner particles such as mixing order, and shape of an agitation blade, revolution speed, mixing time, etc. of a mixer used. Specific examples of the mixers include high-speed mixers such as HENSCHEL MIXER (from Mitsui Mining Co., Ltd.), MECHANOFUSION® (from Hosokawa Micron Ltd.), MECHANOMILL (from Okada Seiko Co., Ltd.), etc., but are not limited thereto.

When the external additive includes a lot of aggregations or coarse particles, or a lot of free external additive particles exist in the mixture, the mixture can be sieved with a mesh having openings of not greater than several hundreds μm or classified. Thereby, the aggregations and the coarse particles can be removed, resulting in control of the amount of free titanium oxide particles.

Amount of Titanium Oxide

The toner for use in the developer of the present invention preferably includes the titanium oxide in an amount of from 0.5 to 1.5% by weight based on total weight of the toner. The amount of the titanium oxide includes all values and subvalues therebetween, especially including 0.6, 0.7, 0.8, 0.9, 1.0, 1.1, 1.2, 1.3 and 1.4% by weight based on total weight of the toner.

When the amount of the titanium oxide is too small, charge quantity of the toner is too high, resulting in deterioration of developability and image density. When the amount of the titanium oxide is too large, titanium oxide particles tend to adhere to the carrier and cause the carrier adherence problem and the toner falling problem, resulting in production of abnormal images having white spots.

The amount of titanium oxide included in the toner is measured by the following method:
(1) Three (3) g of the toner is pelletized using an automatic pressurization forming machine T-BRB-32 (from Maekawa Testing Machine MFG. Co., Ltd.) with a load of 6.0 t and at a pressurization time of 60 seconds, to prepare a pellete of the treated toner having a diameter of 3 mm and a thickness of 2 mm;
(2) The pellet is subjected to quantitative analysis to determine the amount of Ti atom using a fluorescent X-ray spectrometer ZSX-100e (from Rigaku Corporation), in which a calibration curve is prepared in advance using toner pellet samples having 0.1 parts, 1 part and 1.8 parts by weight of titanium oxide, respectively.
   Other External Additives

The toner for use in the developer of the present invention preferably includes a hydrophobized particulate inorganic material having a number average particle diameter of from 80 to 500 nm serving as an external additive (other than the titanium oxide). The number average particle diameter includes all values and subvalues therebetween, especially including 100, 150, 200, 250, 300, 350, 400 and 450 nm.

The hydrophobized particulate inorganic material is preferably a hydrophobized silica. A particulate inorganic material having a large particle diameter hardly embedded in the mother toner particles, while imparting chargeability and fluidity to the toner. Such an external additive having a large particle diameter also serves as a spacer, and reduces occasions of collision and friction between the toner particles. As a result, the titanium oxide having a small particle diameter hardly falls off from the surface of the toner.

The particulate inorganic material having too small particle diameter easily embedded in the mother toner particles, and cannot serve as a spacer. The titanium oxide easily falls off from the surface of the toner, resulting in occurrence of the toner falling problem. In contrast, the particulate inorganic material having too large particle diameter cannot well adhere to the mother toner particles because the total contact area between the particulate inorganic material and the mother toner particles are too small. As a result, free inorganic material particles are produced and deteriorate fluidity and chargeability of the toner. A large mechanical stress is applied to such toner having poor fluidity by being agitated in the developing unit, and thereby the titanium oxide tends to release from the toner and adhere to the carrier. Therefore, charging ability of the carrier deteriorates, resulting in occurrence of the toner falling problem.

Specific examples of the particulate inorganic materials include silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc.

Specific examples of the marketed products of the silica include a fine powder of colloidal silica TT600 (from Nippon Aerosil Co., Ltd.), etc.

Specific examples of the marketed products of the titanium oxide include CR-EL (from Ishihara Sangyo Kaisha, Ltd.), etc.

It is preferable that the silica and/or the titanium oxide are hydrophobized to prevent deterioration of fluidity and chargeability of the toner especially in high-humidity environment. Specific examples of the surface treatment agents include silane coupling agent, silylation agent, silane coupling agent having an alkyl fluoride group, organic titanate coupling agent, aluminum coupling agent, silicone oil, modified silicone oil, etc.

The titanium oxide may have a crystalline structure such as an anatase type and a rutil type, or an amorphous structure. Specific examples of the marketed products of the surface-treated titanium oxide include T-805 (from Nippon Aerosil Co., Ltd.), MT-150AI and MT-150AFM (from Tayca Corporation), STT-30A and STT-30A-FS (from Titan Kogyo Kabushiki Kaisha), etc.

In addition, the toner of the present invention can include external additives other than the silica and the titanium oxide. Specific examples of the external additives other than silica and titanium oxide include particulate inorganic materials such as Al₂O₃, MgO, CuO, ZnO, SnO₂, CeO₂, Fe₂O₃, BaO, CaO, K₂O(TiO₂), Al₂O₃.2SiO₂, CaCO₃, MgCO₃, BaSO₄, MgSO₄, MoS₂, silicon carbide, boron nitride, carbon black, graphite, graphite fluoride, etc.; and particulate polymers such as polystyrene, polycarbonate, polymethyl methacrylate, polyvinylidene fluoride, etc. These can be used alone or in combination. These external additives can be hydrophobized.

The toner for use in the developer of the present invention preferably includes a silica other than the titanium oxide. In mixing process, it is preferable that the titanium oxide is firstly mixed with the mother toner particles, and then the silica is mixed therewith.

By adding the silica after adding the titanium oxide, the titanium oxide strongly fixed to the mother toner particles and hardly release therefrom. Because the silica is less adhesive to the carrier as compared with the titanium oxide, the carrier is hardly contaminated by the silica. Therefore durability of the developer improves. In addition, both good chargeability and good fluidity of the toner can be obtained thereby.

When the titanium oxide is mixed with the mother toner particles together with the silica, or after the silica is mixed therewith, the titanium oxide easily releases from the mother toner particles due to the application of a mechanical stress by agitation in the developing unit. The released titanium oxide particles tend to adhere to the carrier, resulting in production of abnormal images.

Suitable mixers for use in mixing the mother toner particles and an external additive include known mixers for mixing powders, which preferably have a jacket to control the inside temperature thereof. By changing the timing when the external additive is added or the addition speed of the external additive, the stress on the external additive (i.e., the adhesion state of the external additive with the mother toner particles) can be changed. Of course, by changing rotating number of the blade of the mixer used, mixing time, mixing temperature, etc., the stress can also be changed. In addition, a mixing method in which at first a relatively high stress is applied and then a relatively low stress is applied to the external additive, or vice versa, can also be used. Specific examples of the mixers include V-form mixers, locking mixers, Loedge Mixers, NAUTER MIXERS, HENSCHEL MIXERS and the like mixers.

Toner Particles

<Acid Value>

The toner for use in the developer of the present invention preferably includes a binder resin having an acid value of from 10 to 30 KOH/mg. The acid value includes all values and subvalues therebetween, especially including 11, 12, 13, 14, 15, 16, 17, 18, 19, 20, 21, 22, 23, 24, 25, 26, 27, 28 and 29 KOH/mg.

When the acid value is too small, chargeability of the mother toner particles decreases. Thereby, chargeability of the toner also decreases particularly when the external additives are embedded in or released from the mother toner particles, and therefore the toner falling problem occurs. In contrast, when the acid value is too large, chargeability of the mother toner particles increases. Thereby, chargeability of the toner having an external additive served as a fluidizer also increases resulting in deterioration of image density.

The acid value is determined by the method described in JIS K0070. However, when a sample is insoluble in a predetermined solvent, solvents such as dioxane and tetrahydrofuran can be used.

Specific examples of the binder resins include polystyrene resins, epoxy resins, polyester resins, polyamide resins, styrene acryl resins, styrene methacrylate resins, polyurethane resins, vinyl resins, polyolefin resins, styrene butadiene resins, phenol resins, polyethylene resins, silicon resins, butyral resins, terpene resins, polyol resins, etc. These resins can be used alone or in combination.

Specific examples of the vinyl resins include monopolymers of styrene and derivative substitute such as polystyrene, poly-p-chlorostyrene and polyvinyltoluene; copolymers of styrene such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-α-chloro methyl methacrylate copolymers, styrene-acrylonitrile copolymers, styrene-vinyl methyl ether copolymers, styrene-vinyl ethyl ether copolymers, styrene-vinyl methyl ketone copolymers, styrene-butadiene copolymers, styrene-isoprene copolymers, styrene-acrylonitrile-indene copolymers, styrene-maleic acid copolymers and styrene-maleate copolymers; polymethylmethacrylate, polybutylmethacrylate, polyvinylchloride, polyvinylacetate, etc.

Specific examples of the polyester resins are formed by the reaction between diols (A group) and dibasic acids (B group), optionally adding polyols and polycarboxylic acids (C group) having three or more valences. Specific examples of the compounds of A group, B group and C group are shown as follows:

A group: ethylene glycol, triethylene glycol, 1,2-propylene glycol, 1,3-propylene glycol, 1,4-butanediol, neopentyl glycol, 1,4-buenediol, 1,4-bis(hydroxymethyl)cyclohexane, bisphenol A, hydrogenated bisphenol A, polyoxyethylenic bisphenol A, polyoxypropylene(2,2)-2,2′-bis(4-hydroxyphenyl) propane, polyoxypropylene(3,3)-2,2-bis(4-hydroxyphenyl) propane, polyoxyethylene(2,0)-2,2-bis(4-hydroxyphenyl) propane, polyoxypropylene(2,0)-2,2′-bis(4-hydroxyphenyl) propane, etc.;

B group: maleic acid, fumaric acid, mesaconic acid, citraconic acid, itaconic acid, glutaconic acid, phthalic acid, isophthalic acid, terephthalic acid, cyclohexanedicaboxylic acid, succinic acid, adipic acid, sebacic acid, malonic acid, linolenic acid, anhydrides or lower alcohol esters of these compounds, etc.; and

C group: polyols having three valences or more such as glycerine, trimethylolpropane and pentaerythrithol; poly carboxylic acids having three valences or more such as trimellitic acid and pyromellitic acid.

Specific examples of the polyol resins are formed by the reactions between epoxy resins, alkylene oxide adducts or glycidyl ethers of bisphenols, compounds having one active hydrogen reacting to the epoxy group, and compounds having two or more active hydrogen reacting to the epoxy group.

<Charge Controlling Agent>

The toner for use in the developer of the present invention preferably includes a metal complex of salicylic acid as a charge controlling agent.

The metal complex of salicylic acid can impart quickly-charged ability to the toner. Therefore, the toner including the metal complex of salicylic acid hardly falls off from the developing sleeve even if the toner is not sufficiently agitated immediately after a fresh toner is supplied thereto, and even if the toner is used in high-speed machines. Specific preferred examples of suitable metal complexes of salicylic acid include BONTRON® E-84 (from Orient Chemical Industries Co., Ltd.).

It is most preferable that the metal complex of salicylic acid is used alone, but all known charge controlling agents can be used in combination.

Specific examples of the charge controlling agent include Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, salicylic acid derivatives, etc.

Specific examples of the marketed products of the charge controlling agents include BONTRON® N-03 (Nigrosine dyes), BONTRON® P-51 (quaternary ammonium salt), BONTRON® S-34 (metal-containing azo dye), BONTRON® E-82 (metal complex of oxynaphthoic acid), BONTRON® E-84 (metal complex of salicylic acid), and BONTRON® E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE® PSY VP2038 (quaternary ammonium salt), COPY BLUE® PR (triphenyl methane derivative), COPY CHARGE® NEG VP2036 and COPY CHARGE® NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, a quaternary ammonium group, etc.

The content of the charge controlling agent is determined depending on the species of the binder resin used, and toner manufacturing method (such as dispersion method) used, and is not particularly limited. However, the content of the charge controlling agent is typically from 0.1 to 10 parts by weight, and preferably from 0.2 to 5 parts by weight, per 100 parts by weight of the binder resin included in the toner. The content of the charge controlling agent includes all values and subvalues therebetween, especially including 0.5, 1, 1.5, 2, 2.5, 3, 3.5, 4, 4.5, 5, 5.5, 6, 6.5, 7, 7.5, 8, 8.5, 9 and 9.5 parts by weight. When the content is too high, the toner has too large a charge quantity, and thereby the electrostatic force of a developing roller attracting the toner increases, resulting in deterioration of the fluidity of the toner and image density of the toner images.

<Particle Diameter>

The toner for use in the developer of the present invention preferably has a weight average particle diameter of from 4.0 to 11.0 μm. The weight average particle diameter includes all values and subvalues therebetween, especially including 4.5, 5, 5.5, 6, 6.5, 7, 7.5, 8, 8.5, 9, 9.5, 10 and 10.5 μm. When the weight average particle diameter is too small, the toner has poor fluidity and is exposed to a large mechanical stress by agitation in the developing unit. When the weight average particle diameter is too large, the toner is heavy. Such heavy toner is easily affected by the centrifugal force generated by rotation of the developing sleeve and gravity, resulting in occurrence of the toner falling problem.

In addition, the toner of the present invention preferably includes toner particles having a weight average particle diameter of not less than 12.7 μm in an amount of not greater than 8% by volume, and more preferably not less than 3% by volume. The amount of the toner particles having a weight average particle diameter of not less than 12.7 μm includes all values and subvalues therebetween, especially including 7, 6, 5, 4, 3, 2 and 1% by volume. When the amount of such toner particles is too large, the toner tends to fall off due to the centrifugal force.

The weight average particle diameter of the toner can be measured using an instrument COULTER COUNTER TA-II or COULTER MULTISIZER II (from Coulter Electrons Inc). In the present invention, COULTER COUNTER TA-II is connected to an interface (from The Institute of JUSE) calculating number distribution and volume distribution and a personal computer PC9801 (from NEC Corporation).

<Release Agent>

The toner for use in the developer of the present invention preferably includes a wax having a melting point of from 70 to 155° C. as a release agent. The melting point includes all values and subvalues therebetween, especially including 75, 80, 85, 90, 95, 100, 105, 110, 115, 120, 125, 130, 135, 140, 145 and 150° C.

When the melting point is too low, the toner has poor fluidity and is exposed to a large mechanical stress by agitation in the developing unit. When the melting point is too high, such a wax cannot work as a release agent and fixability of the toner deteriorates.

The melting point of the wax is measured using TG-DSC system TAS-100 (from Rigaku Corporation). About 10 mg of a wax is put in an aluminum sample container, and then the sample container is put on a holder unit and set in an electric furnace. The sample is heated from room temperature to 180° C. at a heating speed of 10° C./min. The melting point is determined by finding a contact point of tangent line of an endothermic curve, obtained by an analysis system of TAS-100, near the melting point (i.e., a peak of the endothermic curve) and a baseline.

Specific examples of the waxes include vegetable waxes such as carnauba wax, cotton wax, haze wax and rice wax; animal waxes such as beeswax and lanoline; mineral waxes such as ozokerite and ceresin; and petroleum waxes such as paraffin, microcrystalline and petrolatum.

Specific examples of the waxes other than the above-mentioned natural waxes include synthetic hydrocarbon waxes such as Fischer-Tropsch wax and polyethylene wax; synthetic waxes such as ester, ketone and ether.

In addition, fatty acid amides such as 12-hydroxystearic acid amide, stearic acid amide, phthalic anhydride imide and chlorinated hydrocarbon; crystalline polymers having long alkyl side chains such as homopolymers and copolymers of polyacrylate, i.e., low-molecular-weight crystalline polymer resin, such as poly-n-stearylmethacrylate and poly-n-laurylmethacrylate (for example, copolymer of n-stearylacrylate and ethylmethacrylate); can be used.

<Average Circularity>

The toner for use in the developer of the present invention preferably has an average circularity of from 0.91 to 1.00. The average circularity includes all values and subvalues therebetween, especially including 0.92, 0.93, 0.94, 0.95, 0.96, 0.97, 0.98 and 0.99.

When the average circularity is too small, the toner has an irregular shape and is exposed to a large mechanical stress by friction with the carrier, resulting in production of free external additive particles.

The circularity of a particle is determined by the following equation:
C=Lo/L
wherein C represents the circularity, Lo represents the length of the circumference of a circle having the same area as that of the image of the particle and L represents the peripheral length of the image of the particle. The circularity indicates the irregularity of the toner particle. When the toner is completely spherical, C is 1.00. When the toner shape becomes more complex, the circularity decreases.

The average circularity of the toner can be determined by a flow-type particle image analyzer, FPIA-2000 manufactured by Sysmex Corp.

Specifically, the method is as follows:
(1) 0.1 g to 0.5 g of a sample to be measured is mixed with 100 ml to 150 ml of water from which solid impurities have been removed and which includes 0.1 ml to 0.5 ml of a dispersant (i.e., a surfactant) such as an alkylbenzene sulfonic acid salt;
(2) the mixture is dispersed using an ultrasonic dispersing machine for about 1 to 3 minutes to prepare a suspension including particles of 3,000 to 10,000 per micro-liter of the suspension; and
(3) the average circularity and circularity distribution of the sample in the suspension are determined by the measuring instrument mentioned above.
   <Shape Factor>

The toner for use in the developer of the present invention preferably has a shape factor SF-1 of from 100 to 180 and another shape factor SF-2 of from 100 to 180. The shape factor SF-1 includes all values and subvalues therebetween, especially including 110, 115, 120, 125, 130, 135, 140, 145, 150, 155, 160, 165, 170 and 175. The shape factor SF-2 includes all values and subvalues therebetween, especially including 110, 115, 120, 125, 130, 135, 140, 145, 150, 155, 160, 165, 170 and 175.

When the SF-1 is 100, the toner particles have true spherical forms. When the SF-1 is larger than 100, the toner particles have irregular forms. When the SF-2 approaches 100, the toner particles have a smooth surface (i.e., the toner has few concavity and convexity). When the SF-2 is large, the toner particles are roughened. When SF-1 and SF-2 are larger than 180, the toner is exposed to a large mechanical stress by friction with the carrier.

The shape factor SF-1 represents the degree of the roundness of a toner particle, and is defined by the following equation:
SF-1={(MXLNG)²/(AREA)}×(100π/4)
wherein MXLNG represents a diameter of the circle circumscribing the image of a toner particle, which image is obtained by observing the toner particle with a microscope; and AREA represents the area of the image.

The shape factor SF-2 represents the degree of the concavity and convexity of a toner particle, and is defined by the following equation:
SF-2={(PERI)²/(AREA)}×(100π/4)
wherein PERI represents the peripheral length of the image of a toner particle observed by a microscope; and AREA represents the area of the image.
<Toner Manufacturing Method>

The toner for use in the developer of the present invention is preferably prepared by the following method:
(1) toner constituents including a binder resin and/or a precursor of a binder resin, a release agent, etc. are dissolved or dispersed in an organic solvent or a monomer to prepare a toner constituent mixture liquid; and
(2) the toner constituent mixture liquid is dispersed in an aqueous medium while optionally heating the toner constituent mixture to prepare a dispersion including mother toner particles.

This method is one example of the wet granulation method. The wet granulation method has an advantage over the conventional dry pulverization method (mentioned below) in terms of not producing coarse toner particles having a particle diameter of larger than 12.7 μm. Because such coarse toner particles easily fall off from the developing sleeve, a toner manufactured by the wet granulation method hardly causes the toner fall.

The wet granulation methods include suspension polymerization, emulsion polymerization, dispersion polymerization, emulsion aggregation, emulsion association, etc.

Of course, the toner for use in the developer of the present invention can be prepared by the dry pulverization method. One of the examples of the dry pulverization method is as follows:
(1) toner constituents such as a binder resin, a colorant, a release agent, a charge controlling agent and other additives are mixed well using a mixer such as HENSCHEL mixers;
(2) the mixture is kneaded using a kneader such as batch kneaders (e.g., two-roll mills and BUMBURY'S mixers), and continuous kneaders such as double axis kneaders (e.g., TWIN SCREW EXTRUDER KTK from Kobe Steel, Ltd., TWIN SCREW COMPOUNDER TEM from Toshiba Machine Co., Ltd., MIRACLE K.C.K from Asada Iron Works Co., Ltd., TWIN SCREW EXTRUDER PCM from Ikegai Co., Ltd) and single axis kneaders (e.g., KOKNEADER from Buss Corporation);
(3) the kneaded mixture is cooled by rolling;
(4) the cooled mixture is cut, and crushed;
(5) the crushed mixture is coarsely pulverized with a pulverizer such as hummer mills;
(6) the coarsely pulverized mixture is finely pulverized with a pulverizer such as fine pulverizers utilizing a jet stream and mechanical pulverizers;
(7) the finely pulverized mixture is classified with a classifier such as classifiers utilizing circulated air and classifiers utilizing the Coanda effect, to prepare a mother toner; and
(8) the mother toner is mixed with an external additives including a titanium oxide using a mixer, followed by sieving with a mesh having an openings of not less than 250-mesh if desired, resulting in preparation of a pulverization toner.

The toner for use in the developer of the present invention is preferably prepared by the wet granulation method mentioned above. The materials used for the toner prepared by the wet granulation method mentioned above, and the manufacturing method of the toner will be explained below.

<Polyester>

The polyester resin preferably includes at least a resin having an acid value of from 10 to 30 KOHmg/g. Plural resins can be used in combination.

The polyester resin is formed by polycondensation reaction between a polyol and a polycarboxylic acid.

As the polyol (PO), diols (DIO) and polyols (TO) having three or more valences can be used, and diols (DIO) alone or mixtures of a diol and a small amount of a polyol are preferably used.

Specific examples of diol (DIO) include alkylene glycols such as ethylene glycol, 1,2-propylene glycol, 1,3-propylene glycol, 1,4-butanediol and 1,6-hexanediol; alkylene ether glycols such as diethylene glycol, triethylene glycol, dipropylene glycol, polypropylene glycol and polytetramethylene ether glycol; alicylic diols such as 1,4-cyclohexanedimethanol and hydrogenated bisphenol A; bisphenols such as bisphenol A, bisphenol F and bisphenol S; adducts of the above-mentioned alicyclic diol with an alkylene oxide such as ethylene oxide, propylene oxide and butylenes oxide; and adducts of the above mentioned bisphenol with an alkylene oxide such as ethylene oxide, propylene oxide and butylenes oxide. In particular, an alkylene glycol having 2 to 12 carbon atoms and adducts of bisphenol with an alkylene oxide are preferably used, and a mixture thereof is more preferably used.

Specific examples of the polyols (TO) having three or more valences include multivalent aliphatic alcohols having three or more valences such as glycerin, trimethylolethane, trimethylolpropane, pentaerythritol and sorbitol; phenols having three or more valences such as trisphenol PA, phenolnovolak and cresolnovolak; and adducts of the above-mentioned polyphenol having three or more valences with an alkylene oxide.

As the polycarboxylic acid (PC), dicarboxylic acids (DIC) and polycarboxylic acids (TC) having three or more valences can be used. Dicarboxylic acids (DIC) alone, or mixtures of a dicarboxylic acid and a small amount of a polycarboxylic acid are preferably used.

Specific examples of the dicarboxylic acids (DIC) include alkylene dicarboxylic acids such as succinic acid, adipic acid and sebacic acid; alkenylene dicarboxylic acids such as maleic acid and fumaric acid; and aromatic dicarboxylic acids such as phthalic acid, isophthalic acid, terephthalic acid and naphthalene dicarboxylic acid. In particular, an alkenylene dicarboxylic acid having 4 to 20 carbon atoms and an aromatic dicarboxylic acid having 8 to 20 carbon atoms are preferably used.

Specific examples of the polycarboxylic acid (TC) having three or more valences include aromatic polycarboxylic acids having 9 to 20 carbon atoms such as trimellitic acid and pyromellitic acid.

The polycarboxylic acid (PC) can be formed from a reaction between one or more of the polyols (PO) and an anhydride or lower alkyl ester of one or more of the above-mentioned acids. Suitable lower alkyl esters include, but are not limited to, methyl esters, ethyl esters, and isopropyl esters.

A polyol (PO) and a polycarboxylic acid (PC) are mixed so that the equivalent ratio ([OH]/[COOH]) between a hydroxyl group [OH] and a carboxylic group [COOH] is typically from 2/1 to 1/1, preferably from 1.5/1 to 1/1, and more preferably from 1.3/1 to 1.02/1.

The polyol (PO) and the polycarboxylic acid (PC) are heated at a temperature of from 150 to 280° C. in the presence of a known catalyst, such as tetrabutoxy titanate or dibutyltinoxide. The water generated by the reaction is removed, under a reduced pressure if desired, to prepare a polyester resin having a hydroxyl group. The polyester resin preferably has a hydroxyl value of not less than 5 mg KOH/g. The polyester resin preferably has an acid value of from 10 to 30 mg KOH/g, and more preferably from 10 to 20 mg KOH/g. The acid value includes all values and subvalues therebetween, especially including 11, 12, 13, 14, 15, 16, 17, 18, 19, 20, 21, 22, 23, 24, 25, 26, 27, 28 and 29 mg KOH/g. In this case, the resultant toner is negatively charged, and increase of toner particles having a charge quantity of not greater than 14 μC/g in absolute value can be prevented even if a large mechanical stress is applied to the toner. When the acid value is too large, chargeability of the resultant toner deteriorates, particularly when the toner is used in an environment of high humidity and high temperature.

The polyester resin preferably has a weight-average molecular weight of from 10,000 to 400,000, and more preferably from 20,000 to 200,000. The weight-average molecular weight includes all values and subvalues therebetween, especially including 20000, 40000, 60000, 80000, 100000, 120000, 140000, 160000, 180000, 200000, 220000, 240000, 260000, 280000, 300000, 320000, 340000, 360000 and 380000. When the weight-average molecular weight is too small, hot offset resistance of the resultant toner deteriorates. When the weight-average molecular weight is too large, low-temperature fixability deteriorates.

In the present invention, a urea-modified polyester is preferably used in combination with the unmodified polyester resin mentioned above.

Specific examples of the urea-modified polyester resin include reaction products of polyester prepolymers (A) having an isocyanate group with amines (B). The polyester prepolymer (A) is formed by reacting the end groups of an unmodified polyester such as carboxyl group and hydroxyl group, with a polyisocyanate (PIC).

Specific examples of the polyisocyanate (PIC) include aliphatic polyisocyanates such as tetramethylenediisocyanate, hexamethylenediisocyanate and 2,6-diisocyanatemethylcaproate; alicyclic polyisocyanates such as isophoronediisocyanate and cyclohexylmethanediisocyanate; aromatic diisocyanates such as tolylenediisocyanate and diphenylmethanediisocyanate; aromatic aliphatic diisocyanates such as α, α, α′, α′,-tetramethylxylylenediisocyanate; isocyanurates; the above-mentioned polyisocyanates blocked with phenol derivatives, oxime and caprolactam; and their combinations.

A polyisocyanate (PIC) is mixed with a polyester so that the equivalent ratio ([NCO]/[OH]) between an isocyanate group [NCO] and polyester having a hydroxyl group [OH] is typically from 5/1 to 1/1, preferably from 4/1 to 1.2/1 and more preferably from 2.5/1 to 1.5/1. The equivalent ratio ([NCO]/[OH]) includes all values and subvalues therebetween, especially including 4.5/1, 4/1, 3.5/1, 3/1, 2.5/1, 2/1 and 1.5/1. When the ratio [NCO]/[OH] is too large, low-temperature fixability of the resultant toner deteriorates. When the ratio [NCO]/[OH] is too small, the urea content in the resultant modified polyester decreases and the hot offset resistance of the resultant toner deteriorates.

The content of the constitutional unit obtained from a polyisocyanate in the polyester prepolymer (A) (having a polyisocyanate group at its ends) is from 0.5 to 40% by weight, preferably from 1 to 30% by weight and more preferably from 2 to 20% by weight. The content of the constitutional unit obtained from a polyisocyanate includes all values and subvalues therebetween, especially including 1, 5, 10, 15, 20, 25, 30 and 35% by weight. When the content is too small, the hot offset resistance of the resultant toner deteriorates, and in addition, the heat resistance and low-temperature fixability of the toner also deteriorate. In contrast, when the content is too large, low-temperature fixability of the resultant toner deteriorates.

The number of the isocyanate groups included in a molecule of the polyester prepolymer (A) is at least 1, preferably from 1.5 to 3 on average, and more preferably from 1.8 to 2.5 on average. When the number of isocyanate groups is less than 1 per molecule, the molecular weight of the urea-modified polyester decreases and the hot offset resistance of the resultant toner deteriorates.

Specific examples of the amines (B) include diamines (B1), polyamines (B2) having three or more amino groups, amino alcohols (B3), amino mercaptans (B4), amino acids (B5) and blocked amines (B6) in which the amino groups in the amines (B1) to (B5) are blocked.

Specific examples of the diamines (B1) include aromatic diamines such as phenylene diamine, diethyltoluene diamine and 4,4′-diaminodiphenyl methane; alicyclic diamines such as 4,4′-diamino-3,3′-dimethyldicyclohexyl methane, diaminocyclohexane and isophoronediamine; aliphatic diamines such as ethylene diamine, tetrametylene diamine and hexamethylene diamine, etc.

Specific examples of the polyamines (B2) having three or more amino groups include diethylene triamine, triethylene tetramine.

Specific examples of the amino alcohols (B3) include ethanol amine and hydroxyethyl aniline.

Specific examples of the amino mercaptan (B4) include aminoethyl mercaptan and aminopropyl mercaptan.

Specific examples of the amino acids (B5) include amino propionic acid and amino caproic acid.

Specific examples of the blocked amines (B6) include ketimine compounds which are prepared by reacting one of the amines (B1) to (B5) with a ketone such as acetone, methyl ethyl ketone and methyl isobutyl ketone; oxazoline compounds, etc. Among these amines (B), diamines (B1) and mixtures in which a diamine is mixed with a small amount of polyamine (B2) are preferably used.

The mixing ratio (i.e., a ratio [NCO]/[NHx]) of the content of the prepolymer (A) having an isocyanate group to the amine (B) is from 1/2 to 2/1, preferably from 1/1.5 to 1.5/1 and more preferably from 1/1.2 to 1.2/1. The mixing ratio includes all values and subvalues therebetween, especially including 1.2/1.8, 1.4/1.6, 1.6/1.4 and 1.8/1.2. When the mixing ratio is too large or too small, the molecular weight of the urea-modified polyester decreases, resulting in deterioration of hot offset resistance of resultant toner.

The urea-modified polyester may include a urethane bonding as well as a urea bonding. The molar ratio (urea/urethane) of the urea bonding to the urethane bonding is from 100/0 to 10/90, preferably from 80/20 to 20/80 and more preferably from 60/40 to 30/70. The molar ratio includes all values and subvalues therebetween, especially including 90/10, 80/20, 70/30, 60/40, 50/50, 40/60, 30/70 and 20/80. When the content of the urea bonding is too small, hot offset resistance of the resultant toner deteriorates.

The urea-modified polyester resin of the present invention can be produced by a method such as a one-shot method. Specifically, a polyol (PO) and a polycarboxylic acid (PC) are heated at a temperature of from 150 to 280° C. in the presence of a known catalyst, such as tetrabutoxy titanate or dibutyltinoxide. The water generated by the reaction is removed, under a reduced pressure if desired, to prepare a polyester resin having a hydroxyl group. The polyester resin is then reacted with a polyisocyanate (PIC) at a temperature of from 40 to 140° C., to prepare a prepolymer (A) having an isocyanate group. Further, the prepolymer (A) is reacted with an amine (B) at a temperature of from 0 to 140° C., to prepare a urea-modified polyester resin.

When a polyisocyanate (PIC) is reacted with a polyester resin, and a polyester prepolymer (A) and an amine (B) are reacted, a solvent can be used if desired. Suitable solvents include solvents which do not react with polyisocyanate (PIC). Specific examples of such solvents include aromatic solvents such as toluene and xylene; ketones such as acetone, methyl ethyl ketone and methyl isobutyl ketone; esters such as ethyl acetate; amides such as dimethylformamide and dimethylacetoamide; ethers such as tetrahydrofuran.

The molecular weight of the urea-modified polyester can optionally be controlled using an molecular weight control agent, if desired. Specific examples of the molecular weight control agent include monoamines such as diethyl amine, dibutyl amine, butyl amine and lauryl amine; and blocked amines, i.e., ketimine compounds prepared by blocking the monoamines mentioned above.

The weight-average molecular weight of the urea-modified polyester resin is not less than 10,000, preferably from 20,000 to 10,000,000 and more preferably from 30,000 to 1,000,000. The weight-average molecular weight includes all values and subvalues therebetween, especially including 20000, 30000, 40000, 50000, 60000, 70000, 80000, 90000, 100000, 200000, 300000, 400000, 500000, 600000, 700000, 800000, 900000, 1000000, 2000000, 3000000, 4000000, 5000000, 6000000, 7000000, 8000000 and 9000000. When the weight-average molecular weight is too small, hot offset resistance of the resultant toner deteriorates. The number-average molecular weight of the urea-modified polyester resin is not particularly limited when the unmodified polyester resin is used in combination. Namely, the weight-average molecular weight of the urea-modified polyester has priority over the number-average molecular weight thereof. However, when the urea-modified polyester resin is used alone, the number-average molecular weight is from 2,000 to 15,000, preferably from 2,000 to 10,000 and more preferably from 2,000 to 8,000. The number-average molecular weight includes all values and subvalues therebetween, especially including 3000, 4000, 5000, 6000, 7000, 8000, 9000, 10000, 11000, 12000, 13000 and 14000. When the number-average molecular weight is too large, the low-temperature fixability of the resultant toner deteriorates, and in addition the glossiness of full color images deteriorates.

In the present invention, it is more preferable to use a unmodified polyester resin in combination with a urea-modified polyester resin than to use the urea-modified polyester resin alone because the low-temperature fixability and glossiness of full color images of the resultant toner improve. The unmodified polyester resin may include a polyester modified with a bond except for a urea bond (i.e. other modifications may be present other than the presence of urea bonding).

It is preferable that the unmodified polyester resin and the urea-modified polyester resin are partially soluble with each other to improve the low-temperature fixability and hot offset resistance of the resultant toner. Therefore, the unmodified polyester resin and the urea-modified polyester resin preferably have similar structures.

A weight ratio between the unmodified polyester resin and the urea-modified polyester resin is from 20/80 to 95/5, preferably from 70/30 to 95/5, more preferably from 75/25 to 95/5, and even more preferably from 80/20 to 93/7. The weight ratio includes all values and subvalues therebetween, especially including 25/75, 30/70, 35/65, 40/60, 45/55, 50/50, 55/45, 60/40, 65/35, 70/30, 75/25, 80/20, 85/15 and 90/10. When the weight ratio of the urea-modified polyester resin is too small, the resultant toner has poor hot offset resistance, thermostable preservability and low-temperature fixability.

In the present invention, the binder resin including an unmodified polyester resin and an urea-modified polyester resin preferably has a glass transition temperature (Tg) of from 45 to 65° C. and more preferably from 45 to 60° C. The glass transition temperature includes all values and subvalues therebetween, especially including 46, 47, 48, 49, 50, 51, 52, 53, 54, 55, 56, 57, 58, 59, 60, 61, 62, 63 and 64° C. When Tg is too low, the heat resistance of the resultant toner deteriorates. When Tg is too high, the low-temperature fixability of the resultant toner deteriorates.

The urea-modified polyester resin tends to exist on the surface of the resultant mother toner particle. Therefore, the toner has a better high temperature preservability than known polyester toners even though the glass transition temperature of the toner is lower than that of the known polyester toners.

Next, the method for manufacturing the toner for use in the present invention will be explained. The toner is preferably prepared by the following method, but is not limited thereto.

(1) At first, a colorant, an unmodified polyester resin, a polyester prepolymer having isocyanate groups and a release agent are dissolved or dispersed in a volatile organic solvent to prepare a toner constituent mixture liquid.

The volatile solvents preferably have a boiling point lower than 100° C. so as to be easily removed after the granulating process. Specific examples of the volatile solvents include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and metyl isobutyl ketone. These solvents can be used alone or in combination. In particular, aromatic solvents such as toluene and xylene, and halogenated hydrocarbons such as methylene chloride, 1,2-dichloroethane, chloroform and carbon tetrachloride are preferably used. The added amount of the organic solvent is generally from 0 to 300 parts, preferably from 0 to 100 parts and more preferably 25 to 70 parts by weight, per 100 parts by weight of the polyester prepolymer.

(2) The thus prepared toner constituent mixture liquid is emulsified in an aqueous medium in the presence of a surfactant and a particulate resin.

Suitable aqueous media include water. In addition, other solvents which can be mixed with water can be added to water. Specific examples of such solvents include alcohols such as methanol, isopropanol and ethylene glycol; dimethylformamide, tetrahydrofuran, cellosolves such as methyl cellosolve, lower ketones such as acetone and methyl ethyl ketone, etc. The content of the aqueous medium to 100 parts by weight of the toner constituent mixture liquid is typically from 50 to 2,000 parts by weight, and preferably from 100 to 1,000 parts by weight. The content of the aqueous medium includes all values and subvalues therebetween, especially including 100, 200, 300, 400, 500, 600, 700, 800, 900, 1000, 1100, 1200, 1300, 1400, 1500, 1600, 1700, 1800 and 1900 parts by weight. When the content is too small, the particulate organic material tends not to be well dispersed, and thereby a toner having a desired particle diameter cannot be prepared. In contrast, when the content is too large, the production costs increase.

When the toner constituent mixture liquid is emulsified in an aqueous medium, dispersants such as surfactants and resin particles, are preferably used.

Specific examples of the surfactants include anionic surfactants such as alkylbenzene sulfonic acid salts, α-olefin sulfonic acid salts and phosphoric acid salts; cationic surfactants such as amine salts (e.g., alkyl amine salts, aminoalcohol fatty acid derivatives, polyamine fatty acid derivatives and imidadoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic surfactants such as fatty acid amine derivatives, polyhydric alcohol derivatives; and ampholytic surfactants such as aniline, dodecyldi(aminoethyl)glycin, di(octylaminoethyl)glycin, and N-alkyl-N,N-dimethylammonium betaine.

By using a fluorine-containing surfactant as the surfactant, good charging properties and good charge rising property can be imparted to the resultant toner. Specific examples of anionic surfactants having a fluoroalkyl group include fluoroalkyl carboxylic acids having from 2 to 10 carbon atoms and their metal salts, disodium perfluorooctanesulfonylglutamate, sodium 3-{ω-fluoroalkyl(C6-C11)oxy}-1-alkyl(C3-C4) sulfonate, sodium 3-{ω-fluoroalkanoyl (C6-C8)-N-ethylamino}-1-propanesulfonate, fluoroalkyl(C11-C20) carboxylic acids and their metal salts, perfluoroalkyl(C7-C13) carboxylic acids and their metal salts, perfluoroalkyl(C4-C12) sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethyl ammonium salts, salts of perfluoroalkyl(C6-C10)-N-ethylsulfonyl glycin, monoperfluoroalkyl(C6-C16)ethylphosphates, etc.

Specific examples of the marketed products of such surfactants include SARFRON® S-111, S-112 and S-113, which are manufactured by Asahi Glass Co., Ltd.; FLUORAD® FC-93, FC-95, FC-98 and FC-129, which are manufactured by Sumitomo 3M Ltd.; UNIDYNE® DS-101 and DS-102, which are manufactured by Daikin Industries, Ltd.; MEGAFACE® F-110, F-120, F-113, F-191, F-812 and F-833 which are manufactured by Dainippon Ink and Chemicals, Inc.; ECTOP® EF-102, 103, 104, 105, 112, 123A, 123B, 306A, 501, 201 and 204, which are manufactured by Tochem Products Co., Ltd.; FUTARGENT® F-100 and F-150 manufactured by Neos; etc.

Specific examples of the cationic surfactants having a fluoroalkyl group include primary, secondary and tertiary aliphatic amines having a fluoroalkyl group, aliphatic quaternary salts such as perfluoroalkyl(C6-C10)sulfoneamidepropyltrimethylammonium salts, benzalkonium salts, benzetonium chloride, pyridinium salts, imidazolinium salts, etc.

Specific examples of the marketed products thereof include SARFRON® S-121 (from Asahi Glass Co., Ltd.); FLUORAD® FC-135 (from Sumitomo 3M Ltd.); UNIDYNE® DS-202 (from Daikin Industries, Ltd.); MEGAFACE® F-150 and F-824 (from Dainippon Ink and Chemicals, Inc.); ECTOP® EF-132 (from Tohchem Products Co., Ltd.); FUTARGENT® F-300 (from Neos); etc.

The resin particles mentioned above are added to stabilize the dispersion of the toner mother particle in an aqueous medium. In addition, inorganic dispersants such as tricalcium phosphate, calcium carbonate, titanium oxide, colloidal silica and hydroxyapatite can also be used.

Further, it is possible to stably disperse the toner constituent mixture liquid in an aqueous liquid using a polymeric protection colloid. Specific examples of such protection colloids include polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, glycerinmonomethacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine). In addition, polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethyl cellulose and hydroxypropyl cellulose, can also be used as the polymeric protective colloid.

As the dispersing machine, known mixers and dispersing machines such as low shearing force type dispersing machines, high shearing force type dispersing machines, friction type dispersing machines, high pressure jet type dispersing machines and ultrasonic dispersing machine can be used. In order to prepare a dispersion including particles having an average particle diameter of from 2 to 20 μm, high shearing force type dispersing machines are preferably used. When high shearing force type dispersing machines are used, the rotation speed of rotors is not particularly limited, but the rotation speed is generally from 1,000 to 30,000 rpm and preferably from 5,000 to 20,000 rpm. In addition, the dispersing time is also not particularly limited, but the dispersing time is generally from 0.1 to 5 minutes for batch dispersing machines. The temperature in the dispersing process is generally 0 to 150° C. (under pressure), and preferably from 40 to 98° C.

(3) An amine (B) is added to be reacted with the polyester prepolymer (A) having isocyanate groups at the time of the emulsification.

This reaction is a crosslinking reaction and/or an elongation reaction of polymer chains. The reaction time of the particles are determined depending on the reactivity of the isocyanate of the prepolymer (A) used with the amine used. However, the reaction time is typically from 10 minutes to 40 hours, and preferably from 2 to 20 hours. The reaction temperature is typically from 0 to 150° C. and preferably from 40 to 98° C. In addition, known catalysts such as dibutyl tin laurate and dioctyl tin laurate can be added, if desired, when the reaction is performed.

(4) After the reaction, the organic solvent is removed from the emulsion (i.e., reaction product), and the reaction product is washed and dried to get the mother toner particle.

In order to prepare a spindle-shape toner particle, the emulsion is gradually heated under a laminar agitating, and then a strong shear is applied to the emulsion in a certain temperature range before removing the solvent. When compounds soluble to both acids and bases, such as calcium phosphate salts, are used as a dispersant, it is preferable that calcium phosphate is dissolved by acids such as hydrochloric acid, followed by washing with water. Enzymes are also usable to remove the dispersant.

In order to prepare a toner having a desired particle diameter, the emulsion can be aged (i.e., the emulsion can be allowed to settle for a predetermined time at a predetermined temperature) before or after the washing and solvent removal process. The aging temperature is preferably from 25 to 50° C., and the aging time is preferably from 10 minutes to 23 hours.

(5) The thus prepared mother toner particles are mixed with a charge controlling agent, and the mixture is mixed with inorganic particles such as silica and titanium oxide, by the known methods such as using a mixer.

The toner having a small diameter and a narrow particle diameter distribution is easily manufactured by the method mentioned above. In addition, the toner shape can be easily controlled so as to be from a spherical form to a spindle form by applying a high shear in the solvent removal process. Moreover, the toner surface condition can also be controlled so as to be smooth or rough.

<Colorants>

The toner for use in the developer of the present invention preferably includes a naphthol pigment as a magenta colorant.

As magenta colorants, organic pigments such as azo pigments (e.g., azo lake pigments, insoluble azo pigments, etc.) and polycyclic pigments (e.g., quinacridone pigments, etc.) have been used. Azo pigments are classified into naphthol pigments and oxynaphthoic acid pigments. Among these pigments, naphthol pigments such as C. I. Pigment Red 49, C. I. Pigment Red 68 and C. I. Pigment Red 184, and quinacridone pigments such as C. I. Pigment Red 122, C. I. Pigment Red 209 and C. I. Pigment Red 206 have been broadly used.

We have found that the toner including a naphthol pigment hardly falls off from the developing sleeve. It is because the naphthol pigment has an affinity for the toner including a wax, and therefore the naphthol pigment can be well dispersed in the toner, resulting in good chargeability of the toner. Specific preferred examples of suitable naphthol pigments include C. I. Pigment Red 49, C. I. Pigment Red 68, C. I. Pigment Red 184 and C. I. Pigment Red 269.

These naphthol pigments can be used alone or in combination with other magenta colorants such as C. I. Pigment Red 5 (e.g., SYMULER FAST CARMINE FB from Dainippon Ink and Chemicals, Inc.), C. I. Pigment Red 18 (e.g., SANYO TOLUIDINE MAROON MEDIUM from SANYO COLOR WORKS, Ltd.), C. I. Pigment Red 21 (e.g., SANYO FAST RED GR from SANYO COLOR WORKS, Ltd.), C. I. Pigment Red 22 (e.g., SYMULAR FAST BRILL SCARLET BG from Dainippon Ink and Chemicals, Inc.), C. I. Pigment Red 57 (e.g., SYMULAR BRILL CARMINE LB from Dainippon Ink and Chemicals, Inc.), C. I. Pigment Red 81 (e.g., SYMULEX RHODAMINE Y TONER F from Dainippon Ink and Chemicals, Inc.), C. I. Pigment Red 112 (e.g., SYMULAR FAST RED FGR from Dainippon Ink and Chemicals, Inc.), C. I. Pigment Red 114 (e.g., SYMULAR FAST CARMINE BS from Dainippon Ink and Chemicals, Inc.), C. I. Pigment Red 122 (e.g., FASTOGEN SUPER MAGENTA RE02 from Dainippon Ink and Chemicals, Inc.), C. I. Pigment Red 269, etc.

The toner for use in the developer of the present invention preferably includes an insoluble azo pigment as a yellow colorant.

As yellow colorants, organic pigments such as azo pigments (e.g., acetoacetic acid arylide disazo pigments, acetoacetic acid imidazolone pigments, etc.) and polycyclic pigments (e.g., quinacridone pigments, threne pigments, etc.) have been used. Among these pigments an acetoacetic acid arylide disazo pigment such as C. I. Pigment Yellow 13 and C. I. Pigment Yellow 17 have been broadly used.

We have found that the toner including an insoluble azo pigment hardly falls off from the developing sleeve. It is because the insoluble azo pigment has an affinity for the toner including a wax, and therefore the insoluble azo pigment can be well dispersed in the toner, resulting in good chargeability of the toner. Specific preferred examples of suitable insoluble azo pigments include C. I. Pigment Yellow 180 and C. I. Pigment Yellow 155 (disazo type).

These insoluble azo pigments can be used alone or in combination with other yellow colorants such as C. I. Pigment Yellow 1 (e.g., SYMULER FAST YELLOW GH from Dainippon Ink and Chemicals, Inc.), C. I. Pigment Yellow 3 (e.g., SYMULER FAST YELLOW 10GH from Dainippon Ink and Chemicals, Inc.), C. I. Pigment Yellow 12 (e.g., SYMULER FAST YELLOW GF from Dainippon Ink and Chemicals, Inc., YELLOW 152 from Arimoto Chemical Co., Ltd, PIGMENT YELLOW GRT from SANYO COLOR WORKS, Ltd., SUMIKA PRINT YELLOW-ST-O from Sumitomo Chemical Co., Ltd., BENZIDINE YELLOW 1316 from Noma Chemical Industry Co., Ltd., SEIKAFAST YELLOW 2300 from Dainichiseika Color & Chemicals Mfg. Co., Ltd. and LIONOL YELLOW GRT from Toyo Ink Mfg. Co., Ltd.), C. I. Pigment Yellow 13 (e.g., SYMULER FAST YELLOW GRF from Dainippon Ink and Chemicals, Inc.), C. I. Pigment Yellow 14 (e.g., SYMULER FAST YELLOW 5GR from Dainippon Ink and Chemicals, Inc.), C. I. Pigment Yellow 17 (e.g., SYMULER FAST YELLOW 8GR from Dainippon Ink and Chemicals, Inc. and LIONOL YELLOW FGNT from Toyo Ink Mfg. Co., Ltd.), C. I. Pigment Yellow 180, C. I. Pigment Yellow 155, etc.

Specific examples of cyan colorants for use in the present invention include C. I. Pigment Blue 15 (e.g., FASTOGEN BLUE GS from Dainippon Ink and Chemicals, Inc. and CHROMOFINE SR from Dainichiseika Color & Chemicals Mfg. Co., Ltd.), C. I. Pigment Blue 16 (e.g., SUMITONE CYANINE BLUE LG from Sumitomo Chemical Co., Ltd.,), C. I. Pigment Blue 15:3 (e.g., CYANINE BLUE GGK from Nippon Pigment Co., Ltd. and LIONOL BLUE FG7351 from Toyo Ink Mfg. Co., Ltd.), C. I. Pigment Green 7 (e.g., PHTHALOCYANINE GREEN from Tokyo Printing Ink Mfg. Co., Ltd), C. I. Pigment Green 36 (e.g., CYANINE GREEN ZYL from Toyo Ink Mfg. Co., Ltd.), etc.

Specific examples of black colorants for use in the present invention include carbon black, spirit black, aniline black (C. I. Pigment Black 1), etc.

The toner preferably include the colorant in an amount of from 0.1 to 15 parts by weight, and more preferably from 0.15 to 9 parts by weight, per 100 parts of the binder resin. The amount of colorant includes all values and subvalues therebetween, especially including 0.5, 1, 2, 3, 4, 5, 6, 7, 8, 9, 10, 11, 12, 13 and 14 parts by weight.

The colorant for use in the present invention can be combined with a resin to be used as a master batch. Specific examples of the resin for use in the master batch pigment or for use in combination with master batch pigment include styrene polymers and substituted styrene polymers such as polystyrene, poly-p-chlorostyrene and polyvinyltoluene; styrene-vinyl copolymers; and other resins such as polymethyl methacrylate, polybuthylmethacrylate, polyvinyl chloride, polyvinyl acetate, polyethylene, polypropylene, polyesters, epoxy resins, epoxy polyol resins, polyurethane resins, polyamide resins, polyvinyl butyral resins, polyacrylic resins, rosin, modified rosins, terpene resins, aliphatic or alicyclic hydrocarbon resins, aromatic petroleum resins, chlorinated paraffin, paraffin waxes, etc. These resins are used alone or in combination.

<Magnetic Material>

The toner for use in the developer of the present invention can include a magnetic material and can be used as a magnetic toner. Specific examples of the magnetic materials include iron oxides such as magnetite, hematite, ferrite, etc.; metals such as cobalt and nickel, and their alloys and mixtures with aluminum, cobalt, copper, lead, magnesium, tin, zinc, antimony, beryllium, bismuth, cadmium, calcium, manganese, selenium, titanium, tungsten, vanadium, etc.

These magnetic materials preferably have an average particle diameter of from 0.1 to 2 μm. The average particle diameter includes all values and subvalues therebetween, especially including 0.2, 0.4, 0.6, 0.8, 1.0, 1.2, 1.4, 1.6 and 1.8 μm. The toner preferably include the magnetic material in an amount of from 20 to 200 parts by weight, and more preferably from 40 to 150 parts by weight, per 100 parts by weight of the binder resin. The amount of magnetic material includes all values and subvalues therebetween, especially including 30, 40, 50, 60, 70, 80, 90, 100, 110, 120, 130, 140, 150, 160, 170, 180 and 190 parts by weight.

Carrier

<Cover Layer>

The carrier for use in the developer of the present invention preferably includes a cover layer including an acrylic resin and/or a silicone resin.

As mentioned above, the titanium oxide, added to the toner for improvement of fluidity and chargeability, easily falls off from the toner and adheres to the carrier. We have found that such free titanium oxide particles hardly adhere to the carrier having a cover layer including an acrylic resin and/or a silicone resin. It is because the silicone resin has so low surface energy that the free titanium oxide particles do not adhere thereto. Therefore, the cover layer does not scraped by titanium oxide particles accumulated thereon.

Specific examples of the silicone resins include any known silicone resins such as straight silicone resins only having organosiloxane bonds, and modified silicone resins modified by resins such as alkyd resins, polyester resins, epoxy resins, acryl resins, urethane resins, etc. Specific examples of the marketed products of the straight silicone resins include KR271, KR255 and KR152 (from Shin-Etsu Chemical Co., Ltd.); SR2400, SR2406 and SR2410 (from Dow Corning Toray Silicone Co., Ltd.); etc. Specific examples of the marketed products of the modified silicone resins include KR206 (alkyd modified), KR5208 (acryl modified), ES1001N (epoxy modified) and KR305 (urethane modified) (from Shin-Etsu Chemical Co., Ltd.); SR2115 (epoxy modified) and SR2110 (alkyd modified) (from Dow Corning Toray Silicone Co., Ltd.); etc. These silicon resins can be used alone, or in combination with a crosslinking agent or a charge controlling agent.

In addition, because the acrylic resin has high adhesiveness and low brittleness, the resultant carrier has good durability, i.e., the cover layer hardly scraped off or peeled off.

Specific examples of the acrylic resins include any known resins including an acrylic component, and are not particularly limited. The acrylic resin can be used alone, or in combination with other agents such as a crosslinking agent. Specific examples of the crosslinking agents include amino resins, acid catalysts, etc., but are not limited thereto. Specific examples of the amino resins include guanamine, melamine, etc., but are not limited thereto. As the acid catalysts, all known compounds having catalysis can be used. Specific examples of the acid catalysts include compounds having an active group such as complete alkylation type, methylol group type, imino group type, methylol/imino group type, etc., but are not limited thereto.

In addition, a combination of the acrylic resin and the silicone resin improves properties of the carrier. As mentioned above, because the acrylic resin has high adhesiveness and low brittleness, the resultant carrier has good durability. However, because the acrylic resin has high surface energy, toner components such as external additives tend to adhere to the carrier, resulting in deterioration of chargeability of the carrier. In contrast, because the silicone resin has low adhesiveness and high brittleness, the resultant carrier has poor durability. However, because the silicone resin has low surface energy, toner components such as external additives tend not to adhere to the carrier. It is important to combine these two resins having opposite properties in good balance to obtain a carrier having both durability and resistance to adherence of toner components.

The cover layer can include other resins in combination with the acrylic resin and/or the silicone resin. Specific examples of the other resins include amino resins such as urea-formaldehyde resins, melamine resins, benzoguanamine resins, urea resins, polyamide resins, epoxy resins; polyvinyl and polyvinylidene resins such as acrylic resins, polymethyl methacrylate resins, polyacrylonitrile resins, polyvinyl acetate resins, polyvinyl alcohol resins, polyvinyl butyral resins; polystyrene resins such as polystyrene resins and styrene-acrylic acid copolymer reins; halogenated olefin resins such as polyvinyl chloride; polyester resins such as polyethylene terephtalate resins and polybutylene terephthalate resins; and polycarbonate resins, polyethylene resins, polyvinyl fluoride resins, polyvinylidene fluoride resins, polytrifluoroethylene resins, polyhexafluoropropylene resins, vinylidene fluoride-acrylic monomer copolymers, vinylidene fluoride-vinyl fluoride copolymers, fluoro terpolymers such as tetrafluoroethylene-(vinylidene fluoride)-(non-fluoride monomer) terpolymers, etc.

<Volume Resistivity>

The carrier for use in the developer of the present invention preferably has a volume resistivity on a logarithm scale of from 10 to 16 Ω·cm. The volume resistivity on a logarithm scale includes all values and subvalues therebetween, especially including 11, 12, 13, 14 and 15 Ω·cm.

A carrier having such a volume resistivity hardly causes the toner falling problem. When the volume resistivity is too small, the cover layer is scraped off with time, resulting in deterioration of frictional charging ability of the carrier. Therefore, toner particles having a charge quantity of not greater than 14 μC/g in absolute value are easily produced. When the volume resistivity is too large, toner components adhered to the carrier hardly release therefrom, resulting in deterioration of durability of the carrier.

The volume resistivity is measured by the following method in the present invention. A carrier is sandwiched between two electrodes of a parallel electrode having a gap of 2 mm, and then subjected to tapping. 30 seconds after DC of 1000 V is applied to the electrodes, a resistance is measured using a high resist meter. The volume resistivity is calculated from the measured resistance.

<Particle Diameter>

The carrier for use in the developer of the present invention preferably has a volume average particle diameter of from 20 to 65 μm. The volume average particle diameter includes all values and subvalues therebetween, especially including 25, 30, 35, 40, 45, 50, 55 and 60 μm.

A carrier having such a volume average particle diameter hardly causes the toner falling problem. When the volume average particle diameter is too small, fluidity of the developer deteriorates and a large mechanical stress is applied to the developer by agitation, and therefore the titanium oxide easily releases from the toner. When the volume average particle diameter is too large, contact area between the toner and the carrier decreases therefore the toner cannot be sufficiently charged, resulting in production of toner particles having a charge quantity of not greater than 14 μC/g in absolute value.

Image Forming Apparatus

The image forming apparatus of the present invention uses the developer of the present invention.

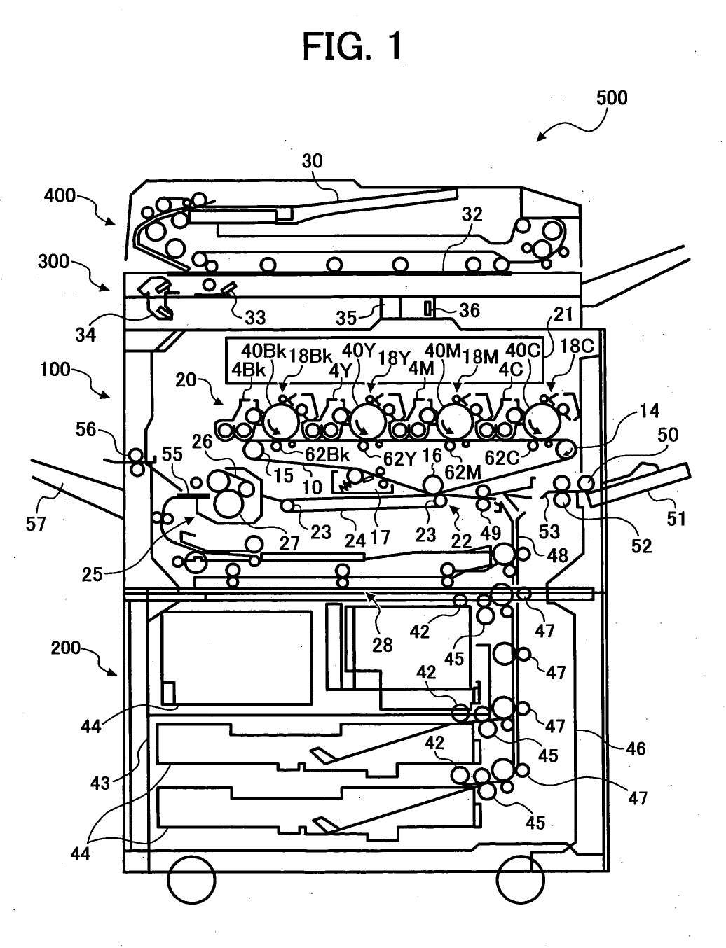

FIG. 1 is a schematic view illustrating an embodiment of the image forming apparatus of the present invention. An image forming apparatus 500 illustrated in FIG. 1 includes a main body 100, a paper feeding table 200, a scanner 300 arranged above the main body and an automatic document feeder (ADF) 400.

The main body 100 includes a tandem-type image forming apparatus 20. The image forming apparatus 20 includes image forming units 18Bk, 18Y, 18M and 18C arranged in parallel. Each of the image forming units 18Bk, 18Y, 18M and 18C includes a respective photoreceptor 40Bk, 40Y, 40M and 40C served as an image bearing member, and electrophotographic image forming devices such as a charging device, a developing device, a cleaning device, etc. are arranged around each of the photoreceptor.

A light irradiator 21, configured to irradiate the photoreceptors 40Bk, 40Y, 40M and 40C with a laser light corresponding to image information to form electrostatic latent images thereon, is arranged above the tandem-type image forming apparatus 20. An intermediate transfer belt 10 made of an endless belt is arranged so as to face the photoreceptors 40Bk, 40Y, 40M and 40C included in the tandem-type image forming apparatus 20. Primary transfer devices 62Bk, 62Y, 62M and 62C configured to transfer toner images formed on each photoreceptors 40Bk, 40Y, 40M and 40C to the intermediate transfer belt 10, are arranged on the opposite side of the intermediate transfer belt 10 relative to the photoreceptors 40Bk, 40Y, 40M and 40C, respectively.

A secondary transfer device 22 configured to transfer the toner image formed on the intermediate transfer belt 10 to a transfer paper fed from the paper feeding table 200, is arranged below the intermediate transfer belt 10. The secondary transfer device 22 includes a secondary transfer belt 24 made of an endless belt tightly stretched by two rollers 23. The secondary transfer device 22 is arranged so as to press a support roller 16 via the intermediate transfer belt 10 so that the toner image formed on the intermediate transfer belt 10 is transferred onto the transfer paper. A fixing device 25 configured to fix the toner image on the transfer paper is arranged beside the secondary transfer device 22. The fixing device 25 includes a fixing belt 26 made of an endless belt and a pressing roller 27. The pressing roller 27 is arranged so as to press the fixing belt 26.

The secondary transfer device 22 feed the transfer paper having the toner image thereon to the fixing device 25. Of course, the secondary transfer device 22 can include a transfer roller or a non-contact charger. But in this case, it is difficult for the secondary transfer device 22 to feed the transfer paper.

The image forming apparatus 500 includes a reverse unit 28 configured to record images on both sides of the transfer paper. The reverse unit 28 is arranged in parallel with the tandem-type image forming apparatus 20 below the secondary transfer device 22 and the fixing device 25.

The image forming units 18Bk, 18Y, 18M and 18C include developing device 4Bk, 4Y, 4M and 4C, respectively. Each of the developing devices contains a developer including a toner. In each of the developing devices 4Bk, 4Y, 4M and 4C, a developer bearing member bears and transports a developer to an area facing an electrostatic latent image formed on each of the photoreceptors 40Bk, 40Y, 40M and 40C, and an AC bias is applied to the area, resulting in development of the electrostatic latent image. By applying the AC bias to the developer, a charge quantity distribution of the toner can be narrowed, and therefore the developability of the toner increases. Because the image forming units 18Bk, 18Y, 18M and 18C are arranged in this order, a black toner image, a yellow toner image, a magenta toner image and a cyan toner image are superimposed on the intermediate transfer belt 10 in this order. However, the full color toner image formed on the intermediate transfer belt 10 turns upside down by being transferred onto the transfer paper with the secondary transfer device. Therefore, the cyan toner image, the magenta toner image, the yellow toner image and the black toner image are superimposed on the transfer paper in this order.

Next, procedure for forming a full color image by the image forming apparatus 500 will be explained. An original document is set to a document feeder 30 included in the automatic document feeder (ADF) 400, or placed on a contact glass 32, included in the scanner 300.

When a start switch button (not shown) is pushed, the scanner 300 starts to drive, and a first runner 33 and a second runner 34 start to move. When the original document is set to the document feeder 30, the scanner 300 starts to drive after the original document is fed on the contact glass 32. The original document is irradiated with a light emitted by a light source via the first runner 33, and the light reflected from the original document is then reflected by a mirror included in the second runner 34. The light passes through an imaging lens 35 and is received by a reading sensor 36. Thus, image information is read.

On the other hand, when the start switch button is pushed, one of support rollers 14, 15 and 16 starts to rotate by a driving motor (not shown), and then another two support rollers start to rotate due to rotation force of the firstly-rotating support roller. Therefore, the intermediate transfer belt 10 starts to rotate. At the same time, a black image, a yellow image, a magenta image and a cyan image are respectively formed on respective photoreceptors 40Bk, 40Y, 40M and 40C in respective image forming units 18Bk, 18Y, 18M and 18C. Each of the color images is transferred one by one onto the intermediate transfer belt 10 so that a full color image is formed thereon.

On the other hand, when the start switch button is pushed, in the paper feeding table 200, a recording paper is fed from one of multistage paper feeding cassettes 44, included in a paper bank 43, by rotating one of paper feeding rollers 42. The recording paper is separated by separation rollers 45 and fed to a paper feeding path 46. Then the recording paper is transported to a paper feeding path 48, included in the main body 100, by transport rollers 47, and is stopped by a registration roller 49.

When the recording paper is fed from a manual paper feeder 51 by rotating a paper feeding roller 50, the recording paper is separated by a separation roller 52 and fed to a manual paper feeding path 53, and is stopped by the registration roller 49.

The recording paper is timely fed to an area formed between the intermediate transfer belt 10 and the secondary transfer device 22, by rotating the registration roller 49, to meet the full color toner image formed on the intermediate transfer belt 10. The full-color toner image is transferred onto the recording paper with the secondary transfer device 22.

The recording paper having the toner image thereon is transported from the secondary transfer device 22 to the fixing device 25. The toner image is fixed on the recording material by application of heat and pressure thereto with the fixing device 25. The recording paper is switched by a switch pick 55 and ejected by an ejection roller 56 and then stacked on an ejection tray 57. When the recording paper is switched by the switch pick 55 to be reversed in the reverse device 28, the recording paper is fed to a transfer area again in order to be formed a toner image on the backside thereof. And then the recording paper is ejected by the ejection roller 56 and stacked on the ejection tray 57.

Toner particles remaining on the intermediate transfer belt 10 are removed using the cleaning device 17 in preparation for the next image forming.

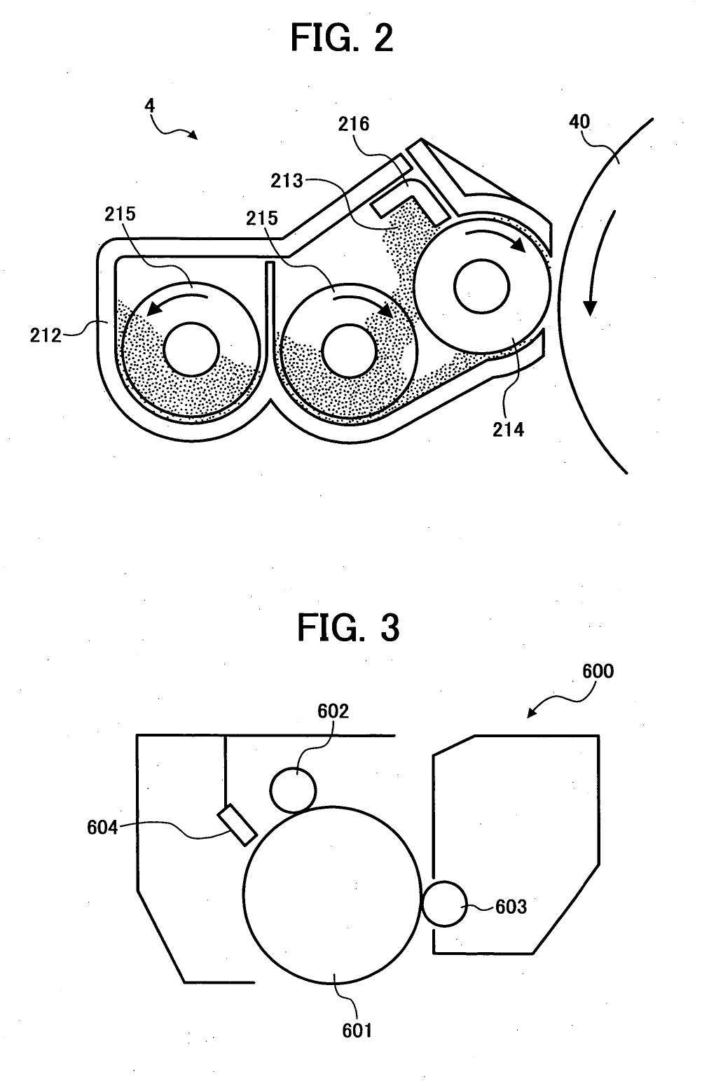

FIG. 2 is a schematic view illustrating an embodiment of the developing device 4Bk, 4Y, 4M and 4C. The developing device 4Bk, 4Y, 4M and 4C have the same configuration, therefore only one developing device is shown in FIG. 2. Symbols Bk, Y, M and C, which represent each of the colors, are omitted from the reference number.

The developing device 4 is arranged so as to face the photoreceptor 40 which is rotated at a constant speed in a direction indicated by an arrow. The developing device 4 has a case 212 having an opening facing the photoreceptor 40. The developing device 4 also includes a developing sleeve 214 configured to bear a layer of a developer 213 thereon. A part of the developing sleeve 214 is exposed to the photoreceptor 40 from the opening of the case 212. The developing sleeve is made of a non-magnetic material and includes a magnetic roller serving as a magnetic field generating means, which includes magnets and is fixed in the developing sleeve. The developing sleeve 214 has a cylindrical form, and is rotated at a constant speed in the direction indicated by an arrow.

The developer 213 is frictionally charged by being agitated in the developing device, so that charged toner particles are adhered to the surface of reversely-charged carrier particles. The developer 213 in the case 212 is fed toward the developing sleeve 214 by paddles 215 which are rotated by a motor (not shown) in the directions indicated by respective arrows. In this case, the developer 213 is attracted to the surface of the developing sleeve 214 by the magnetic roller therein, and thereby magnetic brushes are formed on the surface of the developing sleeve. Then the thickness of the developer 213 (i.e., the magnetic brushes) is controlled by a doctor blade 216, and the developer layer is fed to the developing region. The toner particles present in the developer layer are adhered to an electrostatic latent image because the developing bias is applied to the developing sleeve 214. Thus, the latent image is developed and a toner image is formed on the photoreceptor 40.

<Developing Gap>

The image forming apparatus of the present invention preferably has a developing gap of from 0.25 to 1.25 mm. The developing gap represents a distance between the surface of the developing sleeve and the surface of the photoreceptor. The developing gap includes all values and subvalues therebetween, especially including 0.3, 0.35, 0.4, 0.45, 0.5, 0.55, 0.6, 0.65, 0.7, 0.75, 0.8, 0.85, 0.9, 0.95, 1, 1.05, 1.1, 1.15 and 1.2 mm.

When the developing gap is too small, magnetic brushes formed on the developing sleeve tend to hit the photoreceptor, and thereby the toner adhered to the carrier easily falls off therefrom. When the developing gap is too large, the toner tends to fall off in the developing area due to gravity.

<Doctor Gap>

The image forming apparatus of the present invention preferably has a doctor gap of from 0.4 to 1.5 mm. The doctor gap represents a distance between the surface of the developing sleeve and the surface of the doctor blade. The doctor gap includes all values and subvalues therebetween, especially including 0.5, 0.6, 0.7, 0.8, 0.9, 1.0, 1.1, 1.2, 1.3 and 1.4 mm.

When the doctor gap is too small, magnetic brushes formed on the developing sleeve tend to hit the doctor blade, and thereby the toner adhered to the carrier easily falls off therefrom. When the doctor gap is too large, too much magnetic brushes are formed on the developing sleeve, and thereby not only the toner but also the developer tends to fall off in the developing area due to gravity.

<Developing Speed>

The image forming apparatus of the present invention preferably satisfies the following equation:
1.0≦Vs/Vp≦2.5
wherein Vs represents a line speed of the developing sleeve and Vp represents a line speed of the photoreceptor.

When Vs/Vp is too small, the amount of developed toner is too small, resulting in deterioration of the image density. When Vs/Vp is too large, a large centrifugal force caused by rotation of the developing sleeve is applied to the toner, and thereby the toner easily falls off from the developing sleeve.

<Toner Detection Device and Toner Feed Control Device>

The image forming apparatus of the present invention preferably includes a detection device configured to detect an amount of a toner adhered to the surface of an image bearing member (i.e., a photoreceptor) using a reflective photosensor, and a toner feed control device configured to control an amount of toner fed to the developing device according to the detection result of the detection device.

A predetermined developing bias (i.e., potential difference between an electrostatic image on the photoreceptor and a developing sleeve) is applied to the photoreceptor to form a toner pattern image on the photoreceptor. Then the image background and the toner pattern image are measured by the reflective photosensor.

The toner feed control device controls the amount of toner fed to the developing device according to a ratio Vsp/Vsg, wherein Vsp represents a photosensor output of the image background and Vsg represents a photosensor output of the toner pattern image. By controlling the amount of toner fed to the developing device, the toner concentration in the developer can be controlled, and therefore the charge quantity of the toner can be stabilized. Thereby, toner particles having a charge quantity of not greater than 14 μC/g in absolute value are hardly produced, and therefore the toner hardly falls off from the developing sleeve.

Process Cartridge

The toner of the present invention is used for a process cartridge at least including an image bearing member and a developing device.

FIG. 3 is a schematic view illustrating an embodiment of the process cartridge of the present invention. Such the process cartridge is attachable to and detachable from an image forming apparatus such as copiers and printers.

A process cartridge 600 shown in FIG. 3 includes a photoreceptor 601, a charger 602, a developing device 603 and a cleaning device 604. The photoreceptor 601 rotates at a predetermined speed, and the surface thereof is charged by the charger 602 to reach to a positive or negative predetermined potential while rotating. Then the photoreceptor 601 is irradiated by an imagewise light (i.e. a light carrying image information) emitted by a light irradiator such as a slit irradiator, a laser beam scanning irradiator, etc., to form an electrostatic latent image thereon. The electrostatic latent image is developed with a toner in the developing device 603, and then the toner image is transferred onto a transfer material which is timely fed from a feeding part to an area between the photoreceptor 601 and the transfer device in order to meet the toner images on the photoreceptor 601. The transfer material having the toner images thereon is separated from the photoreceptor 601 and transported to a fixing device so that the toner image is fixed and discharged from the image forming apparatus as a copying or a printing. After the toner image is transferred, residual toner particles remaining on the photoreceptor are removed using the cleaning device 604, and then the photoreceptor is discharged. The photoreceptor 601 is used repeatedly.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

Toner Manufacturing Example 1

<Preparation of Polyester>

The following components were fed in a reaction vessel equipped with a condenser, a stirrer and a nitrogen feed pipe.

| | |
|---|---|
| Ethylene oxide (2 mole) adduct of | 350 parts |
| bisphenol A | |
| Propylene oxide (3 mole) adduct of | 326 parts |
| bisphenol A | |
| Terephthalic acid | 278 parts |
| Phthalic anhydride | 40 parts |
| Dihydroxybis(triethanolaminato) titanium | 2 parts |

The mixture was reacted for 10 hours at 230° C. under nitrogen gas stream while removing water produced by the reaction.

Then the reaction was further continued under a reduced pressure of from 5 to 20 mmHg until the reaction product had an acid value of not greater than 2 KOHmg/g, and then cooled down to 180° C.

Further, 62 parts of trimellitic anhydride was fed to the container to be reacted with the reaction product for 2 hours under normal pressure in the closed vessel, and cooled down to room temperature. The reaction product was pulverized.

Thus, a polyester (a) having an acid value of 32 KOHmg/g was prepared.

<Preparation of Toner>

The following components were mixed and kneaded using a two-roll mill at 70° C.

| | |
|---|---|
| Polyester (a) | 50 parts |
| Magenta pigment (C.I. Pigment Red 269) | 50 parts |
| Purified water | 25 parts |

Then the mixture was kneaded at 120° C. to vaporize the water. Thus, a magenta master batch (1) was prepared.

Next, the following components were mixed.

| | |
|---|---|
| Polyester (a) | 95 parts |
| Magenta master batch (1) | 10 parts |
| Charge controlling agent | 2 parts |
| (BONTRON E-84 from Orient Chemical | |
| Industries, Inc.) | |
| Carnauba wax | 3 parts |

The mixture was kneaded with a two-roll mill for 40 minutes at 50° C., followed by cooling. Then the mixture was subjected to coarse pulverization with a hummer mill, and fine pulverization with an air jet pulverizer. The pulverized particles were classified. Thus, mother toner particles (1) having a weight average particle diameter (D4) of 6.8 μm were prepared.

One hundred (100) parts of the mother toner particles (1) were mixed with 0.15 parts of a zinc stearate (from Sakai Chemical Industry Co., Ltd.), 1 part of a hydrophobized silica (from Clariant (Japan) K. K.) and 1.6 parts of a hydrophobized titanium oxide (from Tayca Corporation) by a mixer. The mixing conditions were as follows:

Revolution: 1000 rpm

Mixing operation: cycle of mixing for 30 sec followed by pause for 60 sec was repeated 6 times

Thus, a toner (1) was prepared.

Carrier Manufacturing Example 1

The following components were mixed for 10 minutes using a mixer TK HOMOMIXER to prepare a coating liquid (1).

| | | |
|---|---|---|
| Silicone resin solution | 132.2 | parts |
| (SR2410 from Dow Corning Toray Silicone Co., Ltd., | | |
| solid content of 23% by weight) | | |
| Aminosilane | 0.66 | parts |
| (SH6020 from Dow Corning Toray Silicone Co., Ltd., | | |
| solid content of 100% by weight) | | |
| Particulate conductive material | 31 | parts |
| (substrate: alumina, inner cover layer: tin dioxide, | | |
| outer cover layer: indium oxide including tin dioxide, | | |
| particle diameter: 0.35 μm, resistivity: 3.5 Ω · cm) | | |
| Toluene | 300 | parts |

The coating liquid (1) was coated on a calcined ferrite having the volume average particle diameter of 35 μm to form a cover layer having the thickness of 0.15 μm thereon, using SPIRA COTA® (from Okada Seiko Co., Ltd.) at an inner temperature of 40° C. and then dried.

The thus coated ferrite was calcined in an electric furnace for 1 hour at 300° C., followed by cooling down. The coated ferrite was sieved with a screen having openings of 63 μm.

Thus, a carrier (1) was prepared. The carrier (1) had a volume resistivity of 12.8 Log(Ω·cm), a magnetization intensity of 68 Am2/kg and a volume average particle diameter of 35.3 μm.

Evaluation

Seven parts of the toner (1) and 93 parts of the carrier (1) were mixed to prepare a two-component developer. The developer was set in a modified copier IMAGIO NEO C600 (manufactured and modified by Ricoh Co., Ltd.), and then a running test in which 5,000 copies are continuously produced per day was performed until 100,000 copies were produced. Three sheets of black solid images (A3), 3 sheets of white solid images (A3) and 3 sheets of S5 image charts (A3) were produced at the beginning of the running test and after 100,000 copies were produced.

<White Spots>

The black solid images were observed to evaluate the number of white spots. The average value of 3 sheets was calculated and graded as follows:

Rank 5: 0

Rank 4: 1 to 5

Rank 3: 6 to 10

Rank 2: 11 to 15

Rank 1: greater than 16

<Background Fouling>

The white solid images were observed to evaluate the area portion of background fouling. An area having a size of 2 cm×2 cm was randomly observed in 5 areas. The average value of 5 areas in 1 sheet was calculated. And then the average value of 3 sheets was calculated and graded as follows:

Rank 5: 0%

Rank 4: 1 to 5%

Rank 3: 6 to 10%

Rank 2: 11 to 15%

Rank 1: greater than 16%

<Image Density>

Solid image parts in the S5 image charts were measured by X-RITE (from X-Rite Incorporated) to determine image density. The average value of 3 sheets was calculated and graded as follows:

Rank 5: not less than 1.50

Rank 4: 1.41 to 1.50

Rank 3: 1.31 to 1.40

Rank 2: 1.21 to 1.30

Rank 1: not greater than 1.20

### Comparative Example 1

The procedure for preparation of the toner (1) in Example 1 was repeated except that the mixing conditions with the external additives were changed to as follows:

Revolution: 1000 rpm

Mixing operation: cycle of mixing for 15 sec followed by pause for 60 sec was repeated 5 times

Thus, a toner (C1) was prepared.

The toner (C1) was mixed with the carrier (1) and evaluated by the same method as Example 1.

### Comparative Example 2

The procedure for preparation of the toner (1) in Example 1 was repeated except that the mixing conditions with the external additives were changed to as follows:

Revolution: 1000 rpm

Mixing operation: cycle of mixing for 10 min followed by pause for 60 sec was repeated 7 times

Thus, a toner (C2) was prepared.

The toner (C2) was mixed with the carrier (1) and evaluated by the same method as Example 1.

### Example 2

The procedure for preparation of the toner (1) in Example 1 was repeated except that the polyester (a) was replaced with a polyester (b) having an acid value of 28 KOHmg/g.

Thus, a toner (2) was prepared.

The toner (2) was mixed with the carrier (1) and evaluated by the same method as Example 1.

### Comparative Example 3

The procedure for preparation of the toner (2) in Example 2 was repeated except that the polyester (b) was replaced with a polyester (c) having an acid value of 8 KOHmg/g.

Thus, a toner (C3) was prepared.

The toner (C3) was mixed with the carrier (1) and evaluated by the same method as Example 1.

### Example 3

The procedure for preparation of the toner (2) in Example 2 was repeated except that the amount of the hydrophobized titanium oxide is changed from 1.6 parts to 1.4 parts.

Thus, a toner (3) was prepared.

The toner (3) was mixed with the carrier (1) and evaluated by the same method as Example 1.

### Example 4

The procedure for preparation of the toner (3) in Example 3 was repeated except that the mixing conditions with the external additives were changed to as follows.

At first, 100 parts of the mother toner particles were mixed with 1.6 parts of the hydrophobized titanium oxide (from Tayca Corporation) by a mixer. The mixing conditions were as follows:

Revolution: 1000 rpm

Mixing operation: cycle of mixing for 2 min followed by pause for 60 sec was repeated 3 times

Next, the mixture was mixed with 0.15 parts of the zinc stearate (from Sakai Chemical Industry Co., Ltd.) and 1 part of the hydrophobized silica (from Clariant (Japan) K. K.) by a mixer. The mixing conditions were as follows:

Revolution: 1000 rpm

Mixing operation: mixing for 2 min

Thus, a toner (4) was prepared.

The toner (4) was mixed with the carrier (1) and evaluated by the same method as Example 1.

The properties of each of the prepared developers are shown in Table 2, and the evaluation results of each of the prepared developers are shown in Table 3.

TABLE 2

| | | | Amount of free | Charge quantity |
|---|---|---|---|---|
| | | | titanium oxide | distribution |
| | | | particles | peak value |
| | Toner | Carrier | (%) | (-μC/g) |
| Ex. 1 | (1) | (1) | 20 | 40 |
| Comp. Ex. 1 | (C1) | (1) | 23 | 40 |
| Comp. Ex. 2 | (C2) | (1) | 3 | 45 |
| Ex. 2 | (2) | (1) | 20 | 34 |
| Comp. Ex. 3 | (C3) | (1) | 20 | 18 |
| Ex. 3 | (3) | (1) | 18 | 36 |
| Ex. 4 | (4) | (1) | 5 | 37 |

TABLE 3

| | | | Image | Background | White |
|---|---|---|---|---|---|
| | Toner | Carrier | density | fouling | spots |
| Ex. 1 | (1) | (1) | 4 | 4 | 4 |
| Comp. Ex. 1 | (C1) | (1) | 4 | 4 | 2 |
| Comp. Ex. 2 | (C2) | (1) | 2 | 4 | 5 |
| Ex. 2 | (2) | (1) | 5 | 5 | 4 |
| Comp. Ex. 3 | (C3) | (1) | 5 | 2 | 4 |
| Ex. 3 | (3) | (1) | 5 | 5 | 5 |
| Ex. 4 | (4) | (1) | 5 | 5 | 5 |

### Example 5

Toner manufacturing example 5

<Preparation of Polyester>

The following components were fed in a four-separable flask equipped with a thermometer, a stainless stirrer, a flow-down condenser and a nitrogen feed pipe.

| | | |
|---|---|---|
| Polyoxypropylene(2,2)-2,2-bis(4-hydroxyphenyl)propane | 390 | parts |
| Isophthalic acid | 120 | parts |
| 1,2,5-benzenetricarboxylic acid | 38 | parts |
| Tin(II) dioctanoate | 1 | part |

The mixture was reacted in a mantle heater at 220° C. under nitrogen gas stream until the reaction product had a target melting point.

Thus, a polyester (d) having an acid value of 9 KOHmg/g was prepared.

<Preparation of Toner>

The following components were mixed and kneaded using a two-roll mill at 70° C.

| | |
|---|---|
| Polyester (a) | 50 parts |
| Magenta pigment (C.I. Pigment Red 122) | 50 parts |
| Purified water | 25 parts |

Then the mixture was kneaded at 120° C. to vaporize the water. Thus, a magenta master batch (2) was prepared.

Next, the following components were mixed.

| | |
|---|---|
| Polyester (a) | 95 parts |
| Magenta master batch (2) | 10 parts |
| Charge controlling agent | 2 parts |
| (fluorine compound) | |
| Carnauba wax | 3 parts |
| (melting point of 68° C.) | |

The mixture was kneaded with a two-roll mill for 40 minutes at 50° C., followed by cooling. Then the mixture was subjected to coarse pulverization with a hummer mill, and fine pulverization with an air jet pulverizer. The pulverized particles were classified. Thus, mother toner particles (5) having a weight average particle diameter (D4) of 6.8 μm were prepared.

One hundred (100) parts of the mother toner particles (5) were mixed with 0.15 parts of a zinc stearate (from Sakai Chemical Industry Co., Ltd.), 1 part of a hydrophobized silica having a number average particle diameter of 75 nm (from Clariant (Japan) K. K.) and 1.6 parts of a hydrophobized titanium oxide (from Tayca Corporation) by a mixer. The mixing conditions were as follows:

Revolution: 1000 rpm

Mixing operation: cycle of mixing for 30 sec followed by pause for 60 sec was repeated 6 times

Thus, a toner (5) was prepared.

Carrier Manufacturing Example 2

The coating liquid (1) prepared above was coated on a calcined ferrite having the volume average particle diameter of 70 μm to form a cover layer having the thickness of 0.15 μm thereon, using SPIRA COTA® (from Okada Seiko Co., Ltd.) at an inner temperature of 40° C. and then dried.

The thus coated ferrite was calcined in an electric furnace for 1 hour at 300° C., followed by cooling down. The coated ferrite was sieved with a screen having openings of 125 μm.

Thus, a carrier (2) was prepared.

Evaluation

Eight parts of the toner (5) and 92 parts of the carrier (2) were mixed to prepare a two-component developer. The developer was set in a modified copier IMAGIO NEO C600 (manufactured and modified by Ricoh Co., Ltd.), and then a running test in which 5,000 copies are continuously produced per day was performed until 100,000 copies were produced. Three sheets of white solid images (A3) and 3 sheets of S5 image charts (A3) were produced at the beginning of the running test and after 100,000 copies were produced.

In addition, to evaluate the contamination level of machine components caused by the toner falling from the developing sleeve, the fallen toner particles were collected on a film tray arranged under the developing sleeve. The weight of the fallen toner was measured.

The modified copier IMAGIO NEO C600 had a developing gap of 1.26 mm, a doctor blade gap of 1.6 mm and a ratio Vs/Vp of 2.6, and a reflective photosensor was turned off.

<Weight of Fallen Toner>

The contamination of the machine components increases as the weight of the fallen toner particles increases. When the weight of the fallen toner particles is less than 500 mg, the produced images have no problem in image quality. When the weight of the fallen toner particles is not less than 500 mg, the produced images have a problem in image quality.

<Background Fouling>

The white solid images were observed to evaluate the number of black spots, and the average value of 3 sheets was calculated. Image quality decreases as the number of black spots increases. When the number of black spots is less than 20, the produced images have no problem in image quality. When the number of black spots is not less than 20, the produced images have a problem in image quality.

<Image Density>

Solid image parts in the S5 image charts were measured by X-RITE (from X-Rite Incorporated) to determine image density, and the average value of 3 sheets was calculated. Image quality decreases as the image density decreases. When the image density is not less than 1.3, the produced images have no problem in image quality. When the image density is less than 1.3, the produced images have a problem in image quality.

### Comparative Example 4

The procedure for preparation of the toner (5) in Example 5 was repeated except that the mixing conditions with the external additives were changed to as follows:

Revolution: 1500 rpm

Mixing operation: cycle of mixing for 60 sec followed by pause for 60 sec was repeated 10 times

Thus, a toner (C4) was prepared.

The toner (C4) was mixed with the carrier (2) and evaluated by the same method as Example 5.

### Comparative Example 5

The procedure for preparation of the toner (5) in Example 5 was repeated except that the mixing conditions with the external additives were changed to as follows.

At first, 100 parts of the mother toner particles were mixed with 0.15 parts of the zinc stearate (from Sakai Chemical Industry Co., Ltd.) and 1 part of the hydrophobized silica having a number average particle diameter of 75 nm (from Clariant (Japan) K. K.) by a mixer. The mixing conditions were as follows:

Revolution: 700 rpm

Mixing operation: cycle of mixing for 10 sec followed by pause for 60 sec was repeated 3 times

Next, the mixture was mixed with 1.6 parts of the hydrophobized titanium oxide (from Tayca Corporation) by a mixer. The mixing conditions were as follows:

Revolution: 700 rpm

Mixing operation: cycle of mixing for 10 sec followed by pause for 60 sec was repeated 3 times

Thus, a toner (C5) was prepared.

The toner (C5) was mixed with the carrier (2) and evaluated by the same method as Example 5.

### Example 6

The procedure for preparation of the toner (5) in Example 5 was repeated except that the hydrophobized silica having a number average particle diameter of 75 nm was replaced with a hydrophobized silica having a number average particle diameter of 81 nm.

Thus, a toner (6) was prepared.

The toner (6) was mixed with the carrier (2) and evaluated by the same method as Example 5.

### Example 7

The procedure for preparation of the toner (5) in Example 5 was repeated except that the mixing conditions with the external additives were changed to as follows.

At first, 100 parts of the mother toner particles were mixed with 1.6 parts of the hydrophobized titanium oxide (from Tayca Corporation) by a mixer. The mixing conditions were as follows:

Revolution: 1000 rpm

Mixing operation: cycle of mixing for 30 sec followed by pause for 60 sec was repeated 6 times

Next, the mixture was mixed with 0.15 parts of the zinc stearate (from Sakai Chemical Industry Co., Ltd.) and 1 part of the hydrophobized silica having a number average particle diameter of 75 nm (from Clariant (Japan) K. K.) by a mixer. The mixing conditions were as follows:

Revolution: 1000 rpm

Mixing operation: cycle of mixing for 30 sec followed by pause for 60 sec was repeated 6 times

Thus, a toner (7) was prepared.

The toner (7) was mixed with the carrier (2) and evaluated by the same method as Example 5.

### Example 8

The procedure for preparation of the toner (5) in Example 5 was repeated except that the polyester (d) was replaced with a polyester (e) having an acid value of 15 KOHmg/g.

Thus, a toner (8) was prepared.

The toner (8) was mixed with the carrier (2) and evaluated by the same method as Example 5.

### Example 9

The procedure for preparation of the toner (5) in Example 5 was repeated except that the fluorine compound served as a charge controlling agent was replaced with BONTRON E-84 (from Orient Chemical Industries, Inc.).

Thus, a toner (9) was prepared.

The toner (9) was mixed with the carrier (2) and evaluated by the same method as Example 5.

### Example 10

The procedure for preparation of the toner (5) in Example 5 was repeated except that pulverization conditions (such as air pressure and pulverization feed) have changed as appropriate so as to prepare a toner having a weight average particle diameter of 7 μm.

Thus, a toner (10) was prepared.

The toner (10) was mixed with the carrier (2) and evaluated by the same method as Example 5.

### Example 11

The procedure for preparation of the toner (5) in Example 5 was repeated except that the carnauba wax having a melting point of 68° C. was replaced with a wax having a melting point of 81° C.

Thus, a toner (11) was prepared.

The toner (11) was mixed with the carrier (2) and evaluated by the same method as Example 5.

### Example 12

The procedure for preparation of the toner (5) in Example 5 was repeated except that the toner was subjected to a thermal treatment so as to transform the toner into a spherical shape.

Thus, a toner (12) was prepared.

The toner (12) was mixed with the carrier (2) and evaluated by the same method as Example 5.

### Example 13

The procedure for preparation of the toner (5) in Example 5 was repeated except that the toner was subjected to a thermal treatment stronger than that performed in Example 12 so as to transform the toner into a spherical shape.

Thus, a toner (13) was prepared.

The toner (13) was mixed with the carrier (2) and evaluated by the same method as Example 5.

### Example 14

The procedure for preparation of the toner (5) in Example 5 was repeated except that C. I. Pigment Red 122 was replaced with C. I. Pigment Red 184.

Thus, a toner (14) was prepared.

The toner (14) was mixed with the carrier (2) and evaluated by the same method as Example 5.

### Example 15

Preparation of Particulate Resin

In a reaction vessel equipped with a stirrer and a thermometer, 683 parts of water, 11 parts of a sodium salt of sulfate of an ethylene oxide adduct of methacrylic acid (ELEMINOL RS-30 from Sanyo Chemical Industries Ltd.), 80 parts of styrene, 83 parts of methacrylic acid, 110 parts of butyl acrylate, 12 parts of butyl thioglycolate and 1 part of ammonium persulfate were contained and the mixture was agitated with the stirrer for 15 minutes at a revolution of 400 rpm. As a result, a milky emulsion was prepared. Then the emulsion was heated to 75° C. to react the monomers for 5 hours.

Further, 30 parts of a 1% aqueous solution of ammonium persulfate were added thereto, and the mixture was aged for 5 hours at 75° C. Thus, an aqueous dispersion (i.e., particle dispersion (1)) of a vinyl resin (i.e., a copolymer of styrene/methacrylic acid/butyl acrylate/sodium salt of sulfate of ethylene oxide adduct of methacrylic acid) was prepared.

The particulate vinyl resin had a volume average particle diameter of 120 nm determined by a laser diffraction and scattering type particle size distribution analyzer LA-920 (manufactured by Horiba Ltd.).

Preparation of Water Phase

990 parts of water, 65 parts of the particle dispersion (1) prepared above, 37 parts of an aqueous solution of a sodium salt of dodecyldiphenyletherdisulfonic acid (ELEMINOL MON-7 (trademark) from Sanyo Chemical Industries Ltd., solid content of 48.5%), and 90 parts of ethyl acetate were mixed. As a result, a water phase (1) was prepared.

Preparation of Low Molecular Weight Polyester

The following components were fed in a reaction vessel equipped with a condenser, a stirrer and a nitrogen feed pipe.

| | |
|---|---|
| Ethylene oxide (2 mole) adduct of | 229 parts |
| bisphenol A | |
| Propylene oxide (3 mole) adduct of | 529 parts |
| bisphenol A | |
| Terephthalic acid | 208 parts |
| Adipic acid | 46 parts |
| Dibutyltin oxide | 2 parts |

The mixture was reacted for 8 hours at 230° C. under normal pressure.

Then the reaction was further continued for 5 hours under a reduced pressure of 10 to 15 mmHg.

Further, 44 parts of trimellitic anhydride was fed to the container to be reacted with the reaction product for 2 hours at 180° C. Thus, a low molecular weight polyester (1) was prepared.

Preparation of Prepolymer

The following components were fed in a reaction vessel equipped with a condenser, a stirrer and a nitrogen feed pipe.

| | |
|---|---|
| Ethylene oxide (2 mole) adduct of | 682 parts |
| bisphenol A | |
| Propylene oxide (2 mole) adduct of | 81 parts |
| bisphenol A | |
| Terephthalic acid | 283 parts |
| Trimellitic anhydride | 22 parts |
| Dibutyl tin oxide | 2 parts |

The mixture was reacted for 8 hours at 230° C. under normal pressure.

Then the reaction was further continued for 5 hours under a reduced pressure of 10 to 15 mmHg. Thus, an intermediate polyester resin (1) was prepared. The intermediate polyester (1) had a number average molecular weight (Mn) of 2,100, a weight average molecular weight (Mw) of 9,500, a glass transition temperature (Tg) of 55° C., an acid value of 0.5 mgKOH/g and a hydroxyl value of 51 mgKOH/g.

In a reaction vessel equipped with a condenser, a stirrer and a nitrogen feed pipe, 410 parts of the intermediate polyester resin (1), 89 parts of isophorone diisocyanate and 500 parts of ethyl acetate were mixed and the mixture was heated at 100° C. for 5 hours to perform the reaction. Thus, a polyester prepolymer (1) having an isocyanate group was prepared. A content of free isocyanate in the prepolymer (1) was 1.53% by weight.

Synthesis of Ketimine Compound

In a reaction vessel equipped with a stirrer and a thermometer, 170 parts of isophorone diamine and 75 parts of methyl ethyl ketone were mixed and reacted for 5 hours at 50° C. to prepare a ketimine compound (1). The ketimine compound (1) had an amine value of 418 mgKOH/g.

Preparation of Oil Phase Liquid

In a reaction vessel equipped with a stirrer and a thermometer, 400 parts of the low molecular weight polyester (1), 110 parts of a carnauba wax, and 947 parts of ethyl acetate were mixed and the mixture was heated to 80° C. while agitated. After being heated at 80° C. for 5 hours, the mixture was cooled to 30° C. over 1 hour. Then 500 parts of the master batch (2) and 500 parts of ethyl acetate were added to the vessel, and the mixture was agitated for 1 hour to prepare a raw material dispersion (1).

Then 1324 parts of the raw material dispersion (1) were subjected to a dispersion treatment using a bead mill (ULTRAVISCOMILL (trademark) from Aimex Co., Ltd.). The dispersing conditions were as follows.

Liquid feeding speed: 1 kg/hour

Peripheral speed of disc: 6 m/sec

Dispersion media: zirconia beads with a diameter of 0.5 mm

Filling factor of beads: 80% by volume

Repeat number of dispersing operation: 3 times (3 passes)

Then 1324 parts of a 65% ethyl acetate solution of the low molecular weight polyester (1) prepared above was added thereto. The mixture was subjected to the dispersion treatment using the bead mill. The dispersion conditions are the same as those mentioned above except that the dispersion operation was performed once (i.e., one pass).

Thus, a colorant/wax dispersion (1) was prepared. A solid content of the colorant/wax dispersion (1) was 50% at 130° C., 30 minutes.

Emulsification

Then the following components Were mixed in a vessel.

| | |
|---|---|
| Colorant/wax dispersion (1) prepared above | 648 parts |
| Prepolymer (1) prepared above | 154 parts |
| Ketimine compound (1) prepared above | 8.5 parts |
| Tertiary amine compound | 1 part |

The components were mixed for 1 minute using a mixer TK HOMOMIXER (trademark) from Tokushu Kika Kogyo K.K. at a revolution of 5,000 rpm. Thus, an oil phase liquid (1) was prepared.

Then 1200 parts of the water phase (1) prepared above was added thereto. The mixture was agitated for 20 minutes with a mixer TK HOMOMIXER (trademark) at a revolution of 10,000 rpm. As a result, an emulsion (1) was prepared.

Solvent Removal

The emulsion (1) was fed into a container equipped with a stirrer and a thermometer, and the emulsion was heated for 8 hours at 30° C. to remove the organic solvent (ethyl acetate) from the emulsion. Then the emulsion was aged for 4 minutes at 45° C. Thus, a dispersion (1) was prepared.

Washing and Drying

One hundred (100) parts of the dispersion (1) was filtered under a reduced pressure.

The thus obtained wet cake was mixed with 100 parts of ion-exchange water and the mixture was agitated for 10 minutes with a TK HOMOMIXER at a revolution of 12,000 rpm, followed by filtering. Thus, a wet cake (1) was prepared.

The wet cake (1) was mixed with 100 parts of a 10% aqueous solution of sodium hydroxide and the mixture was agitated for 30 minutes with a TK HOMOMIXER at a revolution of 12,000 rpm, followed by filtering under a reduced pressure. Thus, a wet cake (2) was prepared.

The wet cake (2) was mixed with 100 parts of a 10% aqueous solution of hydrochloric acid and the mixture was agitated for 10 minutes with a TK HOMOMIXER at a revolution of 12,000 rpm, followed by filtering. Thus, a wet cake (3) was prepared.

The wet cake (3) was mixed with 300 parts of ion-exchange water and the mixture was agitated for 10 minutes with a TK HOMOMIXER at a revolution of 12,000 rpm, followed by filtering. This washing operation was performed twice. Thus, a wet cake (4) was prepared.

The wet cake (4) was dried for 48 hours at 45° C. using a circulating air drier, followed by sieving with a screen having openings of 75 μm. Thus, polymerization mother toner particles (15) were prepared.

One hundred (100) parts of the mother toner particles (15) were mixed with 0.15 parts of a zinc stearate (from Sakai Chemical Industry Co., Ltd.), 1 part of a hydrophobized silica having a number average particle diameter of 75 nm (from Clariant (Japan) K. K.) and 1.6 parts of a hydrophobized titanium oxide (from Tayca Corporation) by a mixer. The mixing conditions were as follows:

Revolution: 1000 rpm

Mixing operation: cycle of mixing for 30 sec followed by pause for 60 sec was repeated 6 times

Thus, a toner (15) was prepared.

The toner (15) was mixed with the carrier (2) and evaluated by the same method as Example 5.

### Example 16

The procedure for preparation of the toner (5) in Example 5 was repeated except that C. I. Pigment Red 122 was replaced with C. I. Pigment Yellow 180.

Thus, a toner (16) was prepared.

The toner (16) was mixed with the carrier (2) and evaluated by the same method as Example 5.

### Example 17

The procedure for preparation of the carrier (2) in Example 5 was repeated except that the coating liquid (1) was replaced with a coating liquid (2) including the following components.

| | |
|---|---|
| Acrylic resin solution | 39.7 parts |
| (solid content of 50% by weight) | |
| Silicone resin solution | 185.8 parts |
| (SR2410 from Dow Corning Toray Silicone Co., | |
| Ltd., solid content of 20% by weight) | |
| Aminosilane | 0.66 parts |
| (SH6020 from Dow Corning Toray Silicone Co., | |
| Ltd., solid content of 100% by weight) | |
| Particulate conductive material | 31 parts |
| (substrate: alumina, inner cover layer: | |
| tin dioxide, outer cover layer: indium oxide | |
| including tin dioxide, particle diameter: | |
| 0.35 μm, resistivity: 3.5 Ω · cm) | |
| Toluene | 300 parts |

Thus, a carrier (3) was prepared.

The toner (5) was mixed with the carrier (3) and evaluated by the same method as Example 5.

### Example 18

The procedure for preparation of the carrier (2) in Example 5 was repeated except that the carrier manufacturing conditions have changed as appropriate so as to prepare a carrier having a volume resistivty of 12.5 Log(Ω·cm).

Thus, a carrier (4) was prepared.

The toner (5) was mixed with the carrier (4) and evaluated by the same method as Example 5.

### Example 19

The procedure for preparation of the carrier (2) in Example 5 was repeated except that the core having the volume average particle diameter of 70 μm was replaced with a core having the volume average particle diameter of 60 μm.

Thus, a carrier (5) was prepared.

The toner (5) was mixed with the carrier (5) and evaluated by the same method as Example 5.

### Example 20

The evaluation in Example 5 was repeated except that the developing gap of the modified copier IMAGIO NEO C600 was changed from 1.26 mm to 1.19 mm.

### Example 21

The evaluation in Example 5 was repeated except that the doctor gap of the modified copier IMAGIO NEO C600 was changed from 1.6 mm to 1.4 mm.

### Example 22

The evaluation in Example 5 was repeated except that the ratio Vs/Vp of the modified copier IMAGIO NEO C600 was changed from 2.6 to 2.4.

### Example 23

The evaluation in Example 5 was repeated except that the reflective photosensor was turned on.

The properties of each of the prepared developers are shown in Table 4, and the evaluation results of each of the prepared developers are shown in Table 5.

TABLE 4

| | | | | Amount of | |
|---|---|---|---|---|---|
| | | | | toner particles | Amount of |
| | | | Charge | not greater | free |
| | | | quantity | than 14 μC/g | titanium |
| | | | distribution | in absolute | oxide |
| | | | peak value | value | particles |
| | Toner | Carrier | (-μC/g) | (mg/10 g) | (%) |
| Ex. 5 | (5) | (2) | 28 | 0.75 | 21 |
| Comp. Ex. 4 | (C4) | (2) | 19 | 0.85 | 4 |
| Comp. Ex. 5 | (C5) | (2) | 41 | 0.9 | 23 |
| Ex. 6 | (6) | (2) | 25 | 0.76 | 20 |
| Ex. 7 | (7) | (2) | 32 | 0.25 | 5.5 |
| Ex. 8 | (8) | (2) | 35 | 0.70 | 20 |
| Ex. 9 | (9) | (2) | 30 | 0.55 | 21 |
| Ex. 10 | (10) | (2) | 31 | 0.72 | 20 |
| Ex. 11 | (11) | (2) | 29 | 0.77 | 19 |
| Ex. 12 | (12) | (2) | 30 | 0.68 | 17 |
| Ex. 13 | (13) | (2) | 32 | 0.50 | 15 |
| Ex. 14 | (14) | (2) | 30 | 0.55 | 18 |
| Ex. 15 | (15) | (2) | 29 | 0.72 | 20 |
| Ex. 16 | (16) | (2) | 26 | 0.70 | 20 |
| Ex. 17 | (5) | (3) | 27 | 0.54 | 20 |
| Ex. 18 | (5) | (4) | 33 | 0.56 | 21 |
| Ex. 19 | (5) | (5) | 35 | 0.40 | 19 |
| Ex. 20 | (5) | (2) | 28 | 0.75 | 21 |
| Ex. 21 | (5) | (2) | 28 | 0.75 | 21 |
| Ex. 22 | (5) | (2) | 28 | 0.75 | 21 |
| Ex. 23 | (5) | (2) | 28 | 0.75 | 21 |

TABLE 5

| | | | Weight of | | |
|---|---|---|---|---|---|
| | | | fallen toner | Number of | Image |
| | Toner | Carrier | (mg) | black spots | density |
| Ex. 5 | (5) | (2) | 495 | 19 | 1.50 |
| Comp. Ex. 4 | (C4) | (2) | 550 | 22 | 1.55 |
| Comp. Ex. 5 | (C5) | (2) | 800 | 33 | 1.21 |
| Ex. 6 | (6) | (2) | 480 | 17 | 1.52 |
| Ex. 7 | (7) | (2) | 90 | 0 | 1.40 |
| Ex. 8 | (8) | (2) | 180 | 10 | 1.45 |
| Ex. 9 | (9) | (2) | 470 | 16 | 1.48 |
| Ex. 10 | (10) | (2) | 475 | 14 | 1.42 |
| Ex. 11 | (11) | (2) | 490 | 18 | 1.49 |
| Ex. 12 | (12) | (2) | 485 | 17 | 1.47 |
| Ex. 13 | (13) | (2) | 475 | 16 | 1.45 |
| Ex. 14 | (14) | (2) | 482 | 12 | 1.47 |
| Ex. 15 | (15) | (2) | 488 | 17 | 1.49 |
| Ex. 16 | (5) | (2) | 180 | 18 | 1.52 |
| Ex. 17 | (5) | (3) | 250 | 10 | 1.51 |
| Ex. 18 | (5) | (4) | 322 | 9 | 1.42 |
| Ex. 19 | (5) | (5) | 280 | 11 | 1.38 |
| Ex. 20 | (5) | (2) | 370 | 14 | 1.50 |
| Ex. 21 | (5) | (2) | 375 | 16 | 1.45 |
| Ex. 22 | (5) | (2) | 368 | 14 | 1.43 |
| Ex. 23 | (5) | (2) | 470 | 15 | 1.40 |

This document claims priority and contains subject matter related to Japanese Patent Applications Nos. 2005-124586 and 2005-124626, filed on Apr. 22, 2005, and Apr. 22, 2005, respectively, as well as Japanese Patent Applications Nos. 2006-107264 and 2006-107413, both filed Apr. 10, 2006, the entire contents of each of which are incorporated herein by reference.

Having now fully described the invention, it will be apparent to one of ordinary skill in the art that many changes and modifications can be made thereto without departing from the spirit and scope of the invention as set forth therein.

1. A developer, comprising:
a toner; and
a carrier,
wherein the toner comprises:
toner particles comprising:
a binder resin; and
a colorant, and
a titanium oxide as an external additive,
wherein an amount of free titanium oxide particles released from the toner determined by a ultrasonic vibration method is from 5 to 22% by weight per total weight of the toner, and
wherein the toner has a charge quantity distribution property so that a peak is present in a charge quantity range of from 20 to 40 μC/g in absolute value,
wherein the charge quantity distribution of the toner is determined by an increment method in which the developer including the toner is subjected to a blow off treatment to measure a charge quantity of the toner at 23° C. and 55% RH.

2. The developer according to claim 1, wherein the toner comprises toner particles having a charge quantity of not greater than 14 μC/g in absolute value in an amount of not greater than 0.8 mg based on 10 g of the toner.

3. The developer according to claim 1, wherein the toner comprises the titanium oxide in an amount of from 0.5 to 1.5% by weight based on total weight of the toner.

4. The developer according to claim 1, wherein the toner further comprises a particulate hydrophobized inorganic material having a number average particle diameter of from 80 to 500 nm as an external additive.

5. The developer according to claim 1, wherein the toner further comprises a silica, wherein the titanium oxide is firstly mixed with the toner particles, and then the silica is secondly mixed with the toner particles.

6. The developer according to claim 1, wherein the binder resin of the toner particles has an acid value of from 10 to 30 KOHmg/g.

7. The developer according to claim 1, wherein the toner further comprises a metal complex of salicylic acid.

8. The developer according to claim 1, wherein the toner has a weight average particle diameter of from 4.0 to 11.0 μm, and comprises toner particles having a weight average particle diameter of not less than 12.7 μm in an amount of not greater than 8% by volume.

9. The developer according to claim 1, wherein the toner particles further comprise a wax having a melting point of from 70 to 155° C.

10. The developer according to claim 1, wherein the toner has an average circularity of from 0.91 to 1.00.

11. The developer according to claim 1, wherein the toner has a shape factor SF-1 of from 100 to 180 and another shape factor SF-2 of from 100 to 180.

12. The developer according to claim 1, wherein the toner particles are prepared by a method comprising:
dissolving or dispersing at least one member selected from the group consisting of the binder resin and a precursor of the binder resin, and at least one release agent in an organic solvent or a monomer to prepare a toner constituent mixture liquid; and
dispersing the toner constituent mixture liquid in an aqueous medium while optionally heating the toner constituent mixture to prepare a dispersion comprising the toner particles.

13. The developer according to claim 1, wherein the colorant comprises a naphthol pigment.

14. The developer according to claim 1, wherein the colorant comprises an insoluble azo pigment.

15. The developer according to claim 1, wherein the carrier comprises a cover layer comprising a resin selected from the group consisting of an acrylic resin and a silicone resin.

16. The developer according to claim 1, wherein the carrier has a volume resistivity on a logarithm scale of from 10 to 16 Ω·cm.

17. The developer according to claim 1, wherein the carrier has a volume average particle diameter of from 20 to 65 μm.

18. An image forming apparatus, comprising:
an image bearing member configured to bear an electrostatic latent image;
a charging device configured to charge the image bearing member;
a writing device configured to irradiate the charged image bearing member with a light beam to form the electrostatic latent image; and
a developing device configured to develop the electrostatic latent image with a developer comprising a toner to form a toner image on the image bearing member, comprising a developing sleeve and a developing doctor blade;
wherein the developer is the developer according to claim 1.

19. The image forming apparatus according to claim 18, wherein a distance between a surface of the developing sleeve and a surface of the image bearing member is from 0.25 to 1.25 mm.

20. The image forming apparatus according to claim 18, wherein a distance between a surface of the developing sleeve and a surface of the developing doctor blade is from 0.4 to 1.5 mm.

21. The image forming apparatus according to claim 18, which satisfies the following relationship:
1.0≦Vs/Vp≦2.5
wherein Vs represents a line speed of the developing sleeve and Vp represents a line speed of the image bearing member.

22. The image forming apparatus according to claim 18, further comprising:
a detection device comprising a reflective photosensor, configured to detect an amount of the toner adhered to the surface of the image bearing member; and
a toner feed control device configured to control an amount of toner fed to the developing device according to a detection result of the detection device.

23. A process cartridge, comprising:
an image bearing member configured to bear an electrostatic latent image; and
a developing device configured to develop the electrostatic latent image with the developer according to claim 1 to form a toner image on the image bearing member.

24. A toner, comprising:
toner particles comprising:
a binder resin; and
a colorant, and
a titanium oxide as an external additive,
wherein an amount of free titanium oxide particles released from the toner determined by a ultrasonic vibration method is from 5 to 22% by weight per total weight of the toner, and
wherein the toner has a charge quantity distribution property so that a peak is present in a charge quantity range of from 20 to 40 μC/g in absolute value, wherein the charge quantity distribution of the toner is determined by:
an increment method (1) in which a developer comprising the toner at a toner concentration of 7% by weight is subjected to a blow off treatment to measure a charge quantity of the toner at 23° C. and 55% RH, wherein the developer comprises a carrier having a cover layer comprising a silicone resin and having a volume average particle diameter of 35 μm; or,
an increment method (2) in which a developer comprising the toner at a toner concentration of 8% by weight is subjected to a blow off treatment to measure a charge quantity of the toner at 23° C. and 55% RH, wherein the developer comprises a carrier having a cover layer comprising a silicone resin and having a volume average particle diameter of 70 μm.
